(19) United States
(12) Patent Application Publication
(10) Pub. No.: US 2026/0234052 A1
(43) Pub. Date: Aug. 13, 2026

(54) GLASS-CERAMIC ARTICLES HAVING REDUCED SURFACE DEFECTS AND ION-EXCHANGE METHODS FOR MAKING SAME

(71) Applicant: CORNING INCORPORATED, CORNING, NY (US)

(72) Inventors: TIMOTHY EVAN DIMOND, CORNING, NY (US); YUHUI JIN, PAINTED POST, NY (US); SARAH ELIZABETH ROBERTS, PAINTED POST, NY (US); MENG SHANG, PAINTED POST, NY (US); LJERKA UKRAINCZYK, ITHACA, NY (US); SARAH MARIE WATERFIELD, CORNING, NY (US)

(21) Appl. No.: 19/453,379

(22) Filed: Jan. 20, 2026

Related U.S. Application Data
(60) Provisional application No. 63/757,019, filed on Feb. 11, 2025.
(60) Provisional application No. 63/764,204, filed on Feb. 27, 2025.

(51) Int. Cl. C03C 21/00; C03C 10/00

(52) U.S. Cl. CPC C03C 21/002; C03C 10/0027; C03C 2204/04

(57) ABSTRACT

A method for ion-exchanging glass-ceramic substrates, the method comprising: a first contacting step comprising contacting a first glass-ceramic substrate with a molten salt bath comprising at least one of NaNO₃ and KNO₃, whereby (1) lithium ions diffuse from the first glass-ceramic substrate into the molten salt bath to provide a first dissolved lithium ion concentration, and (2) at least one of sodium and potassium ions diffuse from the molten salt bath into the first glass-ceramic substrate, thereby forming a first glass-ceramic article; a pH adjusting step that adjusts a pH of the molten salt bath; a lithium ion scavenging step that adjusts the first dissolved lithium ion concentration; wherein the pH adjusting and lithium ion scavenging steps provide a regenerated molten salt bath having a target pH and a second dissolved lithium ion concentration; and a second contacting step comprising contacting a second glass-ceramic substrate with the regenerated molten salt bath.

### CROSS-REFERENCE TO RELATED APPLICATION

This application claims the benefit of priority under 35 U.S.C. § 119 of U.S. Provisional Application Ser. No. 63/757,019, filed on Feb. 11, 2025, and of U.S. Provisional Application Ser. No. 63/764,204, filed on Feb. 27, 2025, the contents of each of which are relied upon and incorporated herein by reference in their entirety.

### FIELD

The disclosure generally relates to glass-ceramic articles having a reduced amount of surface defects, in particular being substantially free of line defects, as well as ion-exchange methods for producing such glass-ceramic articles.

### BACKGROUND

Glass, glass-ceramics, and ceramics materials are important materials used in a variety of applications. Such materials often are required to be chemically ion exchanged in a molten salt bath to achieve target mechanical properties for particular applications.

During ion exchange, lithium ions diffuse out from the substrate into the molten salt bath, and larger ions from the bath (e.g., sodium and/or potassium) diffuse into the substrate. Over time a build-up of lithium ions occurs in the molten salt bath, and such bath needs to be regenerated to continue with efficiently ion-exchanging substrates.

Common methods for regenerating molten salt baths include adding a lithium ion precipitating agent, such as trisodium phosphate (TSP), in an excess amount. However, such conditions can cause surface staining on the resulting article, which must be removed in a subsequent step. For glass-ceramic articles in particular, the surface of the substrate during ion exchange can also become weakened by various species present in the molten salt bath, causing a low index layer to form. Upon cooling, surface tension can be generated in the low index layer, causing cracking in the surface that appears as line defects. During a subsequent chemical repolishing step, the line defect is opened up and the defect becomes even more visible.

Therefore, there is a need in the art for improved methods for ion exchanging substrates, as well as improved methods for regenerating ion exchange baths. This disclosure is directed toward these, as well as other, important goals.

### SUMMARY

The disclosure relates, in various aspects, to a method for ion-exchanging glass-ceramic substrates, the method comprising:
a first contacting step comprising contacting a first glass-ceramic substrate with a molten salt bath comprising at least one of NaNO₃ and KNO₃, whereby (1) lithium ions diffuse from the first glass-ceramic substrate into the molten salt bath to provide a first dissolved lithium ion concentration, and (2) at least one of sodium and potassium ions diffuse from the molten salt bath into the first glass-ceramic substrate, thereby forming a first glass-ceramic article;
a pH adjusting step comprising adding a pH modifier to the molten salt bath that adjusts a pH of the molten salt bath;
a lithium ion scavenging step comprising contacting a lithium ion scavenger with the molten salt bath that adjusts the first dissolved lithium ion concentration;
wherein the pH adjusting and lithium ion scavenging steps (1) take place simultaneously or sequentially in any order, and (2) in combination provide a regenerated molten salt bath having a pH of 6-8 and a second dissolved lithium ion concentration of 115-250 ppm based on 100 wt. % of a sum total of NaNO₃ and KNO₃, if present; and
a second contacting step comprising contacting a second glass-ceramic substrate with the regenerated molten salt bath, whereby (1) lithium ions diffuse from the second glass-ceramic substrate into the regenerated molten salt bath, and (2) at least one of sodium and potassium ions diffuse from the regenerated molten salt bath into the second glass-ceramic substrate, thereby forming a second glass-ceramic article.

The disclosure relates, in various aspects, to a method for ion-exchanging glass-ceramic substrates, the method comprising:
a first contacting step comprising contacting a first glass-ceramic substrate with a molten salt bath comprising a lithium ion buffer and at least one of NaNO₃ and KNO₃, whereby (1) lithium ions diffuse from the first glass-ceramic substrate into the molten salt bath to provide a first dissolved lithium ion concentration, and (2) at least one of sodium and potassium ions diffuse from the molten salt bath into the first glass-ceramic substrate, thereby forming a first glass-ceramic article;
a pH adjusting step comprising adding a pH modifier to the molten salt bath that adjusts a pH of the molten salt bath;
a lithium ion scavenging step comprising contacting a lithium ion scavenger with the molten salt bath that, in conjunction with the lithium ion buffer, adjusts the first dissolved lithium ion concentration, optionally wherein the lithium ion scavenger comprises a sodium-containing glass-based material having a different composition than the first glass-ceramic substrate;
wherein the pH adjusting and lithium ion scavenging steps (1) take place simultaneously or sequentially in any order, and (2) in combination provide a regenerated molten salt bath having a pH of 9-11 and a second dissolved lithium ion concentration of 115-250 ppm based on 100 wt. % of a sum total of NaNO₃ and KNO₃, if present; and
a second contacting step comprising contacting a second glass-ceramic substrate with the regenerated molten salt bath, whereby (1) lithium ions diffuse from the second glass-ceramic substrate into the regenerated molten salt bath, and (2) at least one of sodium and potassium ions diffuse from the regenerated molten salt bath into the second glass-ceramic substrate, thereby forming a second glass-ceramic article.

The disclosure relates, in various aspects, to a glass-ceramic article produced by the methods herein.

The disclosure relates, in various aspects, to a glass-ceramic article, comprising:
first and second primary surfaces, the first primary surface comprising a textured region, a void having an edge, or both the textured region and the void having the edge;
a first compressive stress layer extending from the first primary surface to a first depth of compression (DOC1) and a second compressive stress layer extending from the second primary surface to a second depth of compression (DOC2);
a central tension region extending from DOC1 to DOC2; and
at least one region that satisfies Equation 1:

$$\vert \frac{( {Ca}_{n} - {Ca}_{n \pm 1} )}{{Ca}_{n}} \vert \times 100 > 15 \% ; \qquad ( Equation 1 )$$

wherein Caₙ is an average normalized intensity of calcium in a first 50 nm region, Ca_{n±1} is an average normalized intensity of calcium in a second 50 nm region immediately adjacent to the first 50 nm region, both the first and second 50 nm regions are within a depth of 25 nm to 5000 nm from the first primary surface, and both Caₙ and Ca_{n±1} are measured by SIMS analysis;
wherein at least one of the textured region and the edge, if present, is substantially free of line defects; and
wherein at least one of the textured region and the edge, if present, is substantially free of a low index layer.

Additional features and advantages of the disclosure will be set forth in the detailed description which follows, and in part will be readily apparent to those skilled in the art from that description or recognized by practicing the aspects as described herein, including the detailed description which follows, the claims, as well as the appended drawings.

It is to be understood that both the foregoing general description and the following detailed description are merely exemplary and are intended to provide an overview or framework for understanding the nature and character of the disclosure and claims. The accompanying drawings are included to provide a further understanding of the disclosure and are incorporated into and constitute a part of this specification. The drawings illustrate various aspects of the disclosure and together with the description serve to explain the principles and operations of the various aspects.

### BRIEF DESCRIPTION OF THE DRAWINGS

The following detailed description can be further understood when read in conjunction with the following drawings. Whenever possible, the same reference numerals will be used throughout the drawings to refer to the same or like parts. It is to be understood that the figures are not drawn to scale and the size of each depicted component or the relative size of one component to another is not intended to be limiting.

FIG. 1 schematically depicts a cross section of an article having compressive stress regions according to aspects described and disclosed herein.

FIG. 2A is a plan view of an exemplary electronic device incorporating any of the articles disclosed herein.

FIG. 2B is a perspective view of the exemplary electronic device of FIG. 2A.

FIG. 3 is a line graph depicting the LiNO3 concentration and pH over several ion exchange runs, as discussed in Example 1.

FIG. 4 is a graph depicting several properties of the glass-ceramic articles produced in several ion exchange runs, as discussed in Example 1.

FIG. 5 is a bar graph depicting surface roughness and haze for several glass-ceramic articles produced in several ion exchange runs, both pre- and post-repolishing, as compared to several comparative articles, as discussed in Example 2.

FIG. 6 is a schematic diagram setting forth a proposed mechanism for how and why a line defect forms and is exacerbated by chemical repolishing, along with inset images of line defects, as discussed in Example 3.

FIG. 7A is an optical image under a microscope of a line defect after chemically repolishing an ion-exchanged glass-ceramic article, as discussed in Example 3.

FIG. 7B is a zoomed-in image of FIG. 7A, as discussed in Example 3.

FIG. 8A is a scanning electron microscopy (SEM) image of a line defect after ion-exchange without chemical repolishing, as discussed in Example 3.

FIG. 8B is an SEM image showing a cross-section of a low index layer on the surface of the article of FIG. 8A, as discussed in Example 3.

FIG. 9 is a graph showing a secondary ion mass spectrometry (SIMS) depth profile for sodium and lithium contents at various positions on a glass-ceramic article, as discussed in Example 3.

FIGS. 10A-10D are SIMS depth profiles for certain elements at various positions on a glass-ceramic article that has been chemically repolished as compared to a glass-ceramic article that has not be chemically repolished.

FIG. 11 is a profile view of a schematic diagram of an article.

FIG. 12 is a graph depicting several properties of the glass-ceramic articles produced in several ion exchange runs, as discussed in Example 5.

FIG. 13A, FIG. 13C, FIG. 13E, and FIG. 13G are optical microscope images of glass-ceramic articles that have been subjected to several ion exchange runs showing no observed line defects, as discussed in Example 5.

FIG. 13B, FIG. 13D, FIG. 13F, and FIG. 13H are zoomed-in images of the articles of FIG. 13A, FIG. 13C, FIG. 13E, and FIG. 13G, respectively, as discussed in Example 5.

### DETAILED DESCRIPTION

In the following description, whenever a group is described as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements or combinations thereof, it is understood that the group may consist of any number of those elements recited, either individually or in combination with each other.

Where a range of numerical values is recited herein, comprising upper and lower values, unless otherwise stated in specific circumstances, the range is intended to include the endpoints thereof, and all integers and fractions within the range. Further, when an amount, concentration, or other value or parameter is given as a range, one or more ranges, or a list of upper values and lower values, this is to be understood as specifically disclosing all ranges formed from any pair of any upper range limit or value and any lower range limit or value, regardless of whether such pairs are separately disclosed.

The term “substantially” may be utilized herein to represent the inherent degree of uncertainty that may be attributed to any quantitative comparison, value, measurement, or other representation. This term is also utilized herein to represent the degree by which a quantitative representation may vary from a stated reference without resulting in a change in the basic function of the subject matter at issue. Thus, for example, a composition that is “substantially free” of any specific component (e.g., Al₂O₃, MgO, or any other component) is one in which the component is not actively added or batched into the composition, but may be present in small amounts as a contaminant (e.g., less than 1000, 500, 400, 300, 200, or 100 ppm), or, if actively added or batched, is present in an amount less than 1 wt. % (e.g., or can be specified to be less than 0.5 wt. %, 0.1 wt. %, or 0.05 wt. %.), based on total amount of the composition (moles or mass for ppm, and mass for wt. %).

As used herein, the term “ion-exchangeable” means that a glass or glass-ceramic has a composition such that it is capable of undergoing chemical strengthening by way of ion exchange. For example, a glass or glass-ceramic having an appropriate structure and containing lithium can undergo ion exchange in a molten salt bath containing sodium and/or potassium so as to replace a portion of the lithium with sodium and/or potassium. Similarly, a glass or glass-ceramic having an appropriate structure and containing sodium can undergo ion exchange in a molten salt bath containing potassium so as to replace a portion of the sodium with potassium. As is known in the art, replacing smaller alkali ions in glass with larger alkali ions results in a compressive stress in the glass or glass-ceramic, thereby strengthening the glass or glass-ceramic. An “appropriate structure” in the glass is one that allows such ion exchange to take place so as to result in a compressive stress and associated strengthening of the glass or glass-ceramic.

As used herein, a “glass” is amorphous (randomly arranged atoms), a “ceramic” has a crystalline structure (ordered atoms), and a “glass-ceramic” is a hybrid of the two, containing both crystalline and amorphous phases; in other words, a “glass-ceramic” is a glass that has been partially crystallized.

Herein, glass, ceramic, and glass-ceramic compositions are expressed in terms of the wt. % of particular components included therein on an oxide bases unless otherwise indicated (e.g., the amounts may instead be expressed in mol. %). Any component having more than one oxidation state may be present in a composition in any oxidation state. However, concentrations of such component are expressed in terms of the oxide in which such component is at its lowest oxidation state unless otherwise indicated.

As used herein, the terms “mass” and “weight” are used interchangeably without any difference in meaning intended.

As used herein, the term “>0” means “greater than zero.” Similarly, terms such as “>0-10” means “greater than zero and less than or equal to 10.” Similar meanings can be ascribed to similar terms that merely have different numbers.

As used herein, a “substrate” means a glass-ceramic that has not been chemically strengthened by ion exchange, whereas an “article” is a glass-ceramic that has been chemically strengthened by ion exchange. While efforts have been made herein to consistently use these terms as just defined, there may exist unintended inconsistent usage. Therefore, context should be taken into account when considering the meaning of such terms.

As used herein, “textured region” means a specific area on a glass-ceramic surface that has a patterned or rough texture, as opposed to the smooth, flat surface of the glass-ceramic that does not have such patterning/rough texturing. In other words, a textured region is a portion of the glass-ceramic surface where a deliberate pattern (can be ordered or random) has been created through techniques such as etching, sandblasting, deposition, and/or chemical treatments, imparting a textured quality, and which generally alters how light interacts with or through the glass surface (e.g., in terms of haze, transmittance, anti-reflection, and so forth). In some aspects, the textured region is characterized by a surface roughness Ra and/or Sq of at least 10 nm, a haze of at least 5%, or any combination thereof. By way of further explanation, in some aspects, certain ion exchange conditions (e.g., bath composition, time, temperature, etc.) can leave a chemical cosmetic residue on the surface of a glass-ceramic article. Separate from this residue, the specific ion exchange conditions can also leave a signature that is characteristic of the ion exchange conditions employed. One way finishers can remove the undesired residue is by mechanical polishing, which ideally removes the residue but retains most of the compressive stress imparted by the ion exchange. This mechanical polishing also removes the chemical signature of the ion exchange method. If the glass-ceramic substrate has been textured prior to ion exchange, then mechanical polishing of the resulting glass-ceramic article obtained from ion exchange would undesirably remove the texturing. Generally, the methods herein employ ion exchange conditions that avoid imparting surface residue (which is an undesired defect, e.g., TSP stain, Na stain, low index layers, line defects, etc.). As a result, there is no need for mechanical polishing to remove the residue, which means that any chemical signature imparted by the ion exchange process is still retained in the glass-ceramic article. As such, it is possible to produce textured glass-ceramic articles that still possess chemical signatures characteristic of the ion exchange process they were subjected to (since mechanical polishing generally is not necessary).

As used herein, “CT*TA” is a quantity calculated by multiplying the central tension (CT) with units of MPa by the integrated tension area with units of MPa*μm. CT*TA has units of MPa²*μm.

As used herein, “haze” means the percentage of transmitted light scattered outside an angular cone of ±2.5° in a sample having a transmission path of about 1 mm and measured in accordance with ASTM procedure D1003.

As used herein, “surface roughness” means a surface roughness value (e.g., root mean square roughness “Sq”; average roughness “Ra”; and so forth) measured by a suitable profilometer following the guidelines of ISO 25178. Unless otherwise specified, “surface roughness” herein refers to Sq roughness (i.e., root mean square roughness).

As used herein, with respect to a “void having an edge,” “an edge of a void,” and similar terminology, the term “void” means an absence or hole within a glass-ceramic article, such as a camera hole or other aperture. The “edge” denotes the immediate boundary or rim that encloses such void. This edge can serve as a unique identifier because it is a region that, due to its non-exposure to a subsequent mechanical polishing process that the primary surface of the glass article may undergo, retains a chemical signature that is characteristic of the ion exchange process it has been subject to. As such, the term “void having an edge” encapsulates the physical presence of the void and its chemically distinguishing property present on the edge that is a result of ion exchange.

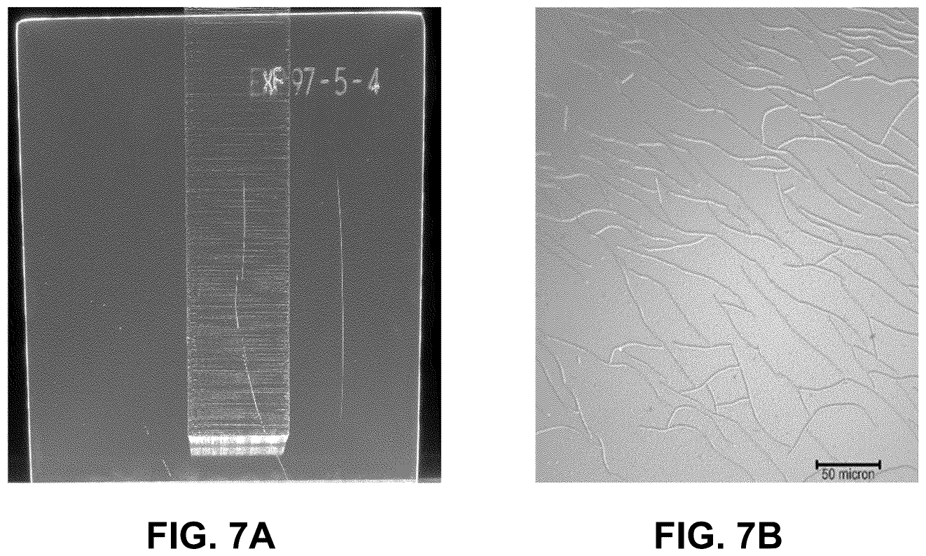

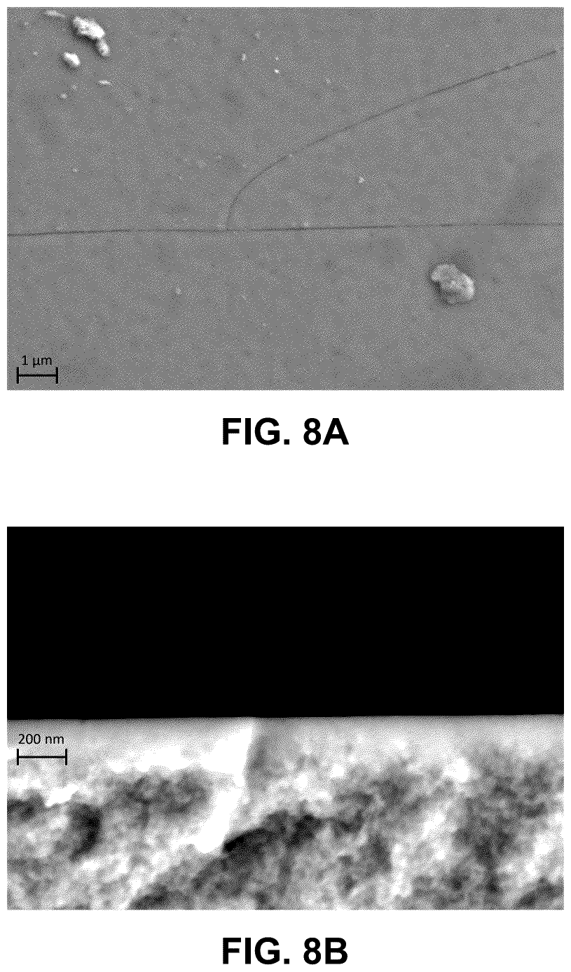

As used herein, a “line defect” is a line-shaped defect on a surface of a glass-ceramic article (which can be on a primary surface and/or on an edge of a void), in which the line has a depth of at least 20 nm (e.g., 20-3000 nm) compared to the surrounding surface. Examples of line defects are shown in FIG. 7A, FIG. 7B, and FIG. 8A. As explained in more detail in Example 3, a line defect is typically, but perhaps not always, caused by a low index layer forming on the surface of a glass-ceramic article during ion exchange. The low index layer has a disrupted glass network, so it is weaker compared to the underlying surface that is ion exchanged but has an intact (not disrupted) glass network. As the article cools after removal from the molten salt bath, the weakened low index layer shrinks and generates a tensile stress that can result in one or more cracks in the low index layer. Such cracks are line defects. The line defects can be exacerbated by a subsequent chemical polishing or repolishing, in which a chemical etchant enters the line defect and etches therein, causing the line defect to open up and become even more visible. A line defect is different and distinct from a scratch.

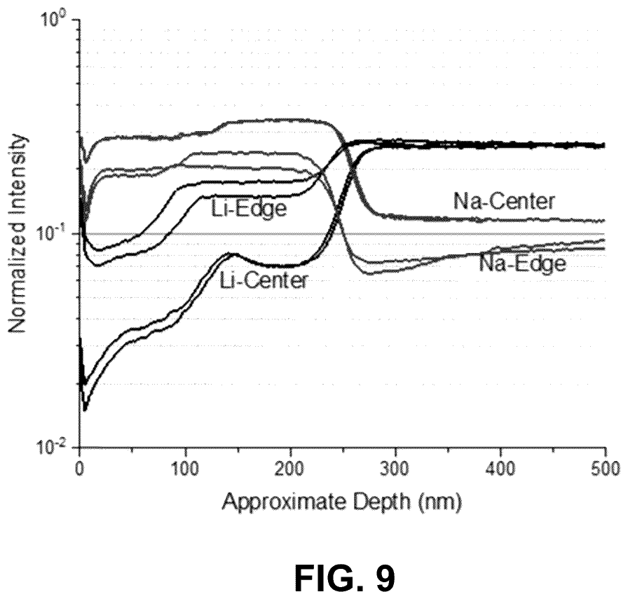

As used herein, a “low index layer” or “low refractive index layer” means a layer rich in sodium ions that can form on the surface of a glass-ceramic (e.g., those containing lithium silicate) under various ion exchange conditions. A low index layer is enriched in sodium ions compared to the underlying bulk article and is typically at least 30 nm thick. The low index layer can be determined using SIMS by measuring approximately the point where the lithium and sodium contents cross (see, e.g., FIG. 9), indicating where IOX-induced alterations of the microstructure and composition are markedly different from the underlying bulk material. The low index layer is explained in more detail in Example 3 and depicted in FIG. 8B (approximately the top ~200-250 nm). The low index layer exhibits lower chemical durability than the underlying bulk substrate, making the layer susceptible to tensile cracking, preferential etching, pitting, and other surface damage.

As used herein, the term “repolished” is a term of art that generally refers to a chemical polishing or etching step performed on a glass-ceramic article after ion exchange. The term “repolish” rather than “polish” is used because typically there has already been a chemical polishing or etching step performed on the glass-ceramic substrate prior to ion exchange. Chemical repolishing after ion exchange can lead to higher haze and higher surface roughness compared to pre-repolishing, since any defects present in the glass can be preferentially etched, exacerbating the effect of such defects.

Glass, glass-ceramics, and ceramics materials are important materials used in a variety of applications. Such materials often are required to be chemically ion exchanged in a molten salt bath to achieve target mechanical properties for particular applications, such as in front and back cover glasses on consumer electronic devices, such as smartphones. In some aspects, a generic process flow for preparing a glass-ceramic article is as follows. In some aspects, a first step is to sandblast the surface of a glass-ceramic substrate. In some aspects, a second step is to chemically etch both of the primary surfaces of the sandblasted glass-ceramic substrate using a chemical etchant comprising hydroxide or hydrofluoric acid (HF). In some aspects, a third step is to mechanically polish one side of the etched and sandblasted glass-ceramic substrate. In some aspects, a fourth step is to ion exchange the etched and sandblasted glass-ceramic substrate in a molten salt bath (using either a new fresh bath, or a regenerated bath) to produce a glass-ceramic article. In some aspects, a fifth step is to chemically repolish both sides of the glass-ceramic article.

During ion exchange, lithium ions diffuse out from the substrate into the molten salt bath, and larger ions from the bath (e.g., sodium and/or potassium) diffuse into the substrate. A build-up of lithium ions occurs in the molten salt bath over time, causing the bath to become “poisoned.” In a poisoned state, dissolved lithium ions in the bath compete with other ions in the bath (e.g., sodium and/or potassium) for diffusion into the substrate, and the strengthening process therefore becomes inefficient or ineffective. To regenerate the poisoned bath, the lithium ion content needs to be reduced.

Some ion-exchange (IOX) processes for glass-ceramics employ a high amount of TSP to regenerate the molten salt baths via precipitation. The use of TSP often raises a concern that TSP staining will occur on the surfaces of the glass-ceramic articles. In particular, in traditional molten salt bath regeneration processes, an additive such as TSP is typically added to selectively precipitate lithium ions from the bath, thereby reducing the dissolved lithium content. However, such additives (e.g., TSP) are typically used in excess, and in combination with the high temperature of the IOX bath, causes surface stains to form on the surfaces of the glass-ceramic article. While alternative IOX methods are available that employ neutral pH chemicals for strengthening glass-ceramics, such methods can cause other surface quality issues, such as low index layers and/or line defects, for example. In particular, nitrate salts in such alternative IOX methods decompose in the bath to form OH ions, which combine with and deactivate Li ions thereby affecting the lithium ion activities. This in turn allows Na ions in the bath to exchange into the substrate without being counterbalanced/controlled by the inhibiting effect of Li ions, thereby contributing to the generation of a poor durability low index layer. If surface tension is generated in this layer, which can be caused by lithium ions diffusing into the low index layer from the molten salt bath and displacing larger ions such as sodium and/or potassium, then the surface will tend to crack, forming line defects (see, e.g., FIG. 7A, FIG. 7B, and FIG. 8A).

Disclosed herein are glass-ceramic articles having improved surface quality, including lower surface roughness, lower/no haze, lower/no low index layer, lower/no line defects, or any combination thereof. Also disclosed herein are methods for regenerating ion-exchange (IOX) molten salt baths that are useful for ion-exchanging glass-ceramics (e.g., glass-ceramics containing lithium silicate and/or petalite). Generally, the IOX methods herein result in glass-ceramic articles having improved surface quality, including lower surface roughness, lower/no haze, lower/no low index layer, lower/no line defects, or any combination thereof. Generally, the IOX methods herein result in a lower surface roughness and/or haze compared to traditional bath regeneration methods that employ the traditional TSP method, and generally the methods herein prevent formation of low index layers and/or line defects.

In some aspects, the methods disclosed herein regenerate a molten salt bath so as to have an approximately neutral pH and a controlled lithium ion concentration; in such aspects, the molten salt baths typically are free or substantially free of a lithium ion buffer (e.g., trisodium phosphate (TSP)), and typically a lithium precipitating additive (e.g., TSP) is not used to regenerate the baths. In other aspects, the methods disclosed herein regenerate a molten salt bath so as to have an approximately weakly alkaline pH and a controlled lithium ion concentration; in such aspects, the molten salt bath typically is preloaded at the outset with a lithium ion buffer (e.g., TSP) (e.g., which can help provide good properties, such as a high CT*TA), and additional lithium ion buffer (e.g., TSP) and/or a lithium precipitating additive (e.g., TSP) typically is not used to regenerate the baths. Such methods, in some aspects, have several advantages. For example, such methods use a controlled amount of lithium ion buffer (e.g., TSP) to prevent surface staining. The staining is typically seen when higher amounts of such a compound (e.g., TSP) are used, since then the additive is not acting as a lithium ion buffer but rather functions by precipitating lithium from the molten salt bath as lithium phosphate (e.g., mono-, di-, and/or tri-lithium phosphate). Such methods also employ a controlled lithium ion concentration (e.g., 115-250 ppm), which helps to prevent formation of a low index layer and prevents creation of tension and subsequent cracks (line defects) within the low index layer and/or surface of the article. A controlled lithium ion concentration also prevents too high an amount of lithium ions from being present, which can inhibit exchange of sodium and/or potassium ions from the bath into the substrate, since such sodium and/or potassium ions would be competing with lithium ions.

Certain methods will now be described, according to some aspects of the disclosure. In particular, in some aspects, a molten salt bath for ion exchange starts (1) at an approximately neutral pH without a lithium ion buffer or high pH chemicals, or (2) at a weakly alkaline pH with a lithium ion buffer. In both cases, in some aspects, the lithium ion concentration is maintained at a desired level, such as between 115-250 ppm. In some aspects, after ion-exchanging a glass-ceramic substrate to produce a glass-ceramic article, the glass-ceramic article is removed from the bath, and the bath is regenerated using a lithium ion scavenger. In some aspects, the glass-ceramic article may be subjected to chemical repolishing using hydrofluoric acid (HF) or a hydroxide (e.g., NaOH, KOH, Mg(OH)₂, Ca(OH)₂, etc.) to remove a small portion (e.g., a layer having a thickness of 0.1-3 μm) from each surface to improve surface quality. The surface of the resulting glass-ceramic article has no or minimized surface staining (e.g., TSP-staining), low surface roughness/haze, low or no low index layer, and low or no cosmetic issues (e.g., line defects).

In some aspects, disclosed is a method for ion-exchanging substrates (e.g., glass-ceramic substrates). The methods herein can generally be divided into two main categories: the first type of method has an approximately neutral pH and typically does not involve the use of TSP, and the second type of method has an approximately weakly alkaline pH and typically involves pre-loading of a lithium ion buffer (e.g., TSP) at the outset but typically no subsequent additions of the lithium ion buffer during regeneration cycles. Most disclosures herein relating to both types of methods are equally applicable, and therefore much of the disclosures of both types of methods overlap. Differences between the two categories will be described where appropriate. In other words, disclosures herein are intended to be freely combinable and applicable to both types of methods to the extent practicable.

In some aspects, disclosed is a method for ion-exchanging substrates (e.g., glass-ceramic substrates). This method generally relates to the approximately neutral pH method. This method generally comprises:
a first contacting step comprising contacting a first glass-ceramic substrate with a molten salt bath comprising at least one of NaNO₃ and KNO₃, whereby (1) lithium ions diffuse from the first glass-ceramic substrate into the molten salt bath to provide a first dissolved lithium ion concentration, and (2) at least one of sodium and potassium ions diffuse from the molten salt bath into the first glass-ceramic substrate, thereby forming a first glass-ceramic article;
a pH adjusting step comprising adding a pH modifier to the molten salt bath that adjusts a pH of the molten salt bath;
a lithium ion scavenging step comprising contacting a lithium ion scavenger with the molten salt bath that adjusts the first dissolved lithium ion concentration;
wherein the pH adjusting and lithium ion scavenging steps (1) take place simultaneously or sequentially in any order, and (2) in combination provide a regenerated molten salt bath having a pH of 6-8 and a second dissolved lithium ion concentration of 115-250 ppm based on 100 wt. % of a sum total of NaNO₃ and KNO₃, if present; and
a second contacting step comprising contacting a second glass-ceramic substrate with the regenerated molten salt bath, whereby (1) lithium ions diffuse from the second glass-ceramic substrate into the regenerated molten salt bath, and (2) at least one of sodium and potassium ions diffuse from the regenerated molten salt bath into the second glass-ceramic substrate, thereby forming a second glass-ceramic article.

In some aspects, disclosed is a method for ion-exchanging substrates (e.g., glass-ceramic substrates). This method generally relates to the approximately alkaline pH method. This method generally comprises:
a first contacting step comprising contacting a first glass-ceramic substrate with a molten salt bath comprising a lithium ion buffer and at least one of NaNO₃ and KNO₃, whereby (1) lithium ions diffuse from the first glass-ceramic substrate into the molten salt bath to provide a first dissolved lithium ion concentration, and (2) at least one of sodium and potassium ions diffuse from the molten salt bath into the first glass-ceramic substrate, thereby forming a first glass-ceramic article;
a pH adjusting step comprising adding a pH modifier to the molten salt bath that adjusts a pH of the molten salt bath;
a lithium ion scavenging step comprising contacting a lithium ion scavenger with the molten salt bath that, in conjunction with the lithium ion buffer, adjusts the first dissolved lithium ion concentration, optionally wherein the lithium ion scavenger comprises a sodium-containing glass-based material having a different composition than the first glass-ceramic substrate;
wherein the pH adjusting and lithium ion scavenging steps (1) take place simultaneously or sequentially in any order, and (2) in combination provide a regenerated molten salt bath having a pH of 9-11 and a second dissolved lithium ion concentration of 115-250 ppm based on 100 wt. % of a sum total of NaNO₃ and KNO₃, if present; and
a second contacting step comprising contacting a second glass-ceramic substrate with the regenerated molten salt bath, whereby (1) lithium ions diffuse from the second glass-ceramic substrate into the regenerated molten salt bath, and (2) at least one of sodium and potassium ions diffuse from the regenerated molten salt bath into the second glass-ceramic substrate, thereby forming a second glass-ceramic article.

In some aspects, the molten salt bath in the first contacting step comprises any suitable composition. For example, in some aspects, the molten salt bath comprises a potassium salt, a sodium salt, or a combination thereof. In some aspects, the molten salt bath comprises KNO₃, NaNO₃, or a combination thereof. Generally, the amounts of additives are expressed herein in terms of 100 wt. % of the base composition of the molten salt bath, i.e., the potassium salt(s) and sodium salt(s), such as KNO₃ and NaNO₃, if present. The concept of expressing components or additives based on 100 wt. % of the base composition is typically termed a superaddition of the additives. Similarly, as used herein, the amounts of the potassium and sodium salts of the molten salt bath (e.g., KNO₃ and/or NaNO₃), i.e., the base composition, are expressed in terms of 100 wt. % of such potassium and sodium salts (e.g., KNO₃ and NaNO₃), if present. In some aspects, the molten salt bath comprises KNO₃ and is free or substantially free of NaNO₃. In some aspects, the molten salt bath comprises NaNO₃ and is free or substantially free of KNO₃. In some aspects, the molten salt bath comprises KNO₃ and NaNO₃. Generally, the regenerated molten salt bath also contains the same base composition (e.g., sodium and/or potassium salts) as the first contacting step's molten salt bath, such that the disclosures herein with respect to the molten salt bath are also applicable to the regenerated molten salt bath. When multiple runs are conducted, such as where a molten salt bath is regenerated to form a regenerated molten salt bath, if that regenerated molten salt bath is then used to ion exchange additional glass-ceramic substrates to form glass-ceramic articles, then the regenerated molten salt bath becomes the first contacting step's molten salt bath in the next run and the subsequent steps are generally carried out as in the first run.

In some aspects, a molten salt bath comprises NaNO₃. Generally, the sodium in the molten salt bath exchanges with lithium ions in the glass-ceramic to produce a compressive stress. In some aspects, the molten salt bath comprises NaNO₃ in an amount (wt. %) of at least 5, at least 10, at least 15, at least 20, at least 25, at least 30, at least 35, at least 40, at least 45, at least 50, at least 55, at least 60, at least 65, at least 70, at least 75, at least 80, at least 85, at least 90, at least 95, at least 99, 100, 100 or less, 95 or less, 90 or less, 85 or less, 80 or less, 75 or less, 70 or less, 65 or less, 60 or less, 55 or less, 50 or less, 45 or less, 40 or less, 35 or less, 30 or less, 25 or less, 20 or less, 15 or less, 10 or less, 5 or less, or any range formed therefrom. For example, in some aspects, the molten salt bath comprises NaNO₃ in an amount (wt. %) of 5-100, 5-95, 5-90, 5-85, 5-80, 5-75, 5-70, 5-65, 5-60, 5-55, 5-50, 5-45, 5-40, 5-35, 5-30, 5-25, 5-20, 5-15, 5-10, 10-100, 10-95, 10-90, 10-85, 10-80, 10-75, 10-70, 10-65, 10-60, 10-55, 10-50, 10-45, 10-40, 10-35, 10-30, 10-25, 10-20, 10-15, 15-100, 15-95, 15-90, 15-80, 15-70, 15-60, 15-50, 15-40, 15-30, 15-20, 20-100, 20-90, 20-80, 20-70, 20-60, 20-50, 20-40, 20-30, 30-100, 30-90, 30-80, 30-70, 30-60, 30-50, 30-40, 40-100, 40-90, 40-80, 40-70, 40-60, 40-50, 50-100, 50-90, 50-80, 50-70, 50-60, 60-100, 60-90, 60-80, 60-70, 70-100, 70-90, 70-80, 80-100, 80-90, or 90-100. In particular, in some aspects the molten salt bath comprises NaNO₃ in an amount (wt. %) of 40-90, 70-85, 75-85, or 50-80. In some aspects, the molten salt bath comprises 100 wt. % of NaNO₃. Any of the amounts herein for NaNO₃ can be combined with the amounts set forth for elsewhere herein for KNO₃, to express the components of a molten salt bath (e.g., the base composition of the molten salt bath). All amounts herein of NaNO₃ are based on 100 wt. % of a sum total of NaNO₃ and KNO₃, if present.

In some aspects, a molten salt bath comprises KNO₃. Generally, the potassium in the molten salt bath exchanges with sodium and/or lithium ions in the glass-ceramic to produce a compressive stress. In some aspects, molten salt bath comprises KNO₃ in an amount (wt. %) of at least 5, at least 10, at least 15, at least 20, at least 25, at least 30, at least 35, at least 40, at least 45, at least 50, at least 55, at least 60, at least 65, at least 70, at least 75, at least 80, at least 85, at least 90, at least 95, at least 99, 100, 100 or less, 95 or less, 90 or less, 85 or less, 80 or less, 75 or less, 70 or less, 65 or less, 60 or less, 55 or less, 50 or less, 45 or less, 40 or less, 35 or less, 30 or less, 25 or less, 20 or less, 15 or less, 10 or less, 5 or less, or any range formed therefrom. For example, in some aspects, the molten salt bath comprises KNO₃ in an amount (wt. %) of 5-100, 5-95, 5-90, 5-85, 5-80, 5-75, 5-70, 5-65, 5-60, 5-55, 5-50, 5-45, 5-40, 5-35, 5-30, 5-25, 5-20, 5-15, 5-10, 10-100, 10-95, 10-90, 10-85, 10-80, 10-75, 10-70, 10-65, 10-60, 10-55, 10-50, 10-45, 10-40, 10-35, 10-30, 10-25, 10-20, 10-15, 15-100, 15-95, 15-90, 15-80, 15-70, 15-60, 15-50, 15-40, 15-30, 15-20, 20-100, 20-90, 20-80, 20-70, 20-60, 20-50, 20-40, 20-30, 30-100, 30-90, 30-80, 30-70, 30-60, 30-50, 30-40, 40-100, 40-90, 40-80, 40-70, 40-60, 40-50, 50-100, 50-90, 50-80, 50-70, 50-60, 60-100, 60-90, 60-80, 60-70, 70-100, 70-90, 70-80, 80-100, 80-90, or 90-100. In particular, in some aspects the molten salt bath comprises KNO₃ in an amount (wt. %) of 10-60, 15-30, 15-25, or 20-50. In some aspects, the molten salt bath comprises 100 wt. % of KNO₃. Any of the amounts herein for KNO₃ can be combined with the amounts set forth for NaNO₃, to express the components of a molten salt bath (e.g., the base composition of the molten salt bath). All amounts herein of KNO₃ are based on 100 wt. % of a sum total of NaNO₃ and KNO₃, if present.

In some aspects, the molten salt bath comprises any suitable combination of NaNO₃ and KNO₃. For example, in some aspects, the molten salt bath comprises 40-90 wt. % NaNO₃ and 10-60 wt. % KNO₃. In some aspects, the molten salt bath comprises 70-85 wt. % NaNO₃ and 15-30 wt. % KNO₃. In some aspects, the molten salt bath comprises 15-25 wt. % NaNO₃ and 75-85 wt. % KNO₃. In some aspects, the molten salt bath comprises 20-50 wt. % NaNO₃ and 50-80 wt. % KNO₃. In some aspects, the molten salt bath comprises 20 wt. % NaNO₃ and 80 wt. % KNO₃. For clarity, it is noted that all references herein to a molten salt bath are also applicable to a regenerated molten salt bath, unless clearly contradicted by context.

Typically during ion exchange, some cations present in a surface of the substrate diffuse out of the substrate and into the molten salt bath. Correspondingly, cations present in the molten salt bath diffuse into the surface of the substrate. The cations in the substrate and the molten salt bath can be any cation, but typically the most relevant cations are lithium ions, sodium ions, and potassium ions, if present. Typically, the cations in the substrate are lithium and/or sodium ions, and the cations in the molten salt bath are sodium and/or potassium ions. Smaller cations in the substrate generally are replaced with larger cations from the molten salt bath, creating a compressive stress in the surface thereof to a depth of compression (DOC). Therefore, in some aspects, during ion exchange, lithium ions diffuse from a substrate into the molten salt bath to provide a dissolved lithium ion concentration, and at least one of sodium and potassium ions diffuse from the molten salt bath into the first glass-ceramic substrate, thereby forming an article.

In some aspects, as an ion exchange process progresses, the lithium ion concentration in the molten salt bath rises due to diffusion of lithium from the substrate into the molten salt bath. In some aspects, the pH of the molten salt bath changes during the ion exchange process due to various factors including the decomposition of components in the bath, diffusion of ions into/out of the substrate, and so forth.

In some aspects, the methods herein comprise a pH adjusting step that comprises adding a pH modifier to the molten salt bath that adjusts a pH of the molten salt bath. In some aspects, the methods herein comprise a lithium ion scavenging step that comprises contacting a lithium ion scavenger with the molten salt bath, which adjusts the first dissolved lithium ion concentration. The pH adjusting step and lithium ion scavenging step can take place simultaneously or sequentially in any order.

In the approximately neutral pH method, generally the combination of the pH adjusting step and the lithium ion scavenging step adjusts both (1) the pH to a target range of, e.g., 6-8, and (2) the dissolved lithium ion concentration to a target range of, e.g., 115-250 ppm. In the approximately weakly alkaline pH method, generally the combination of the pH adjusting step and the lithium ion scavenging step adjusts both (1) the pH to a target range of, e.g., 9-11, and (2) the dissolved lithium ion concentration to a target range of, e.g., 115-250 ppm. A general difference in the approximately weakly alkaline pH method (compared to the approximately neutral pH method, and besides the pH) is that a lithium ion buffer is also present, and a combination of the lithium ion scavenger and the lithium ion buffer adjusts the dissolved lithium ion concentration to the target range of, e.g., 115-250 ppm.

In the approximately weakly alkaline pH method, in some aspects the contacting step comprises a molten salt bath comprising a lithium ion buffer. In some aspects, the weakly alkaline pH method comprises first and second contacting steps, in which a substrate is contacted with a molten salt bath and a regenerated molten salt bath, respectively. Generally, as described elsewhere herein, after the first contacting step the molten salt bath is regenerated using a pH modifier and a lithium ion scavenger to provide a regenerated molten salt bath. In some aspects, the lithium ion buffer employed in a contacting step comprises trisodium phosphate (TSP). In some aspects, both the molten salt bath and the regenerated molten salt bath comprises a lithium ion buffer. In some aspects, a molten salt bath (e.g., a molten salt bath in the first contacting step, a regenerated molten salt bath in a second contacting step, and so forth) comprises a lithium ion buffer in an amount (parts by weight (pbw)) of at least 0.05, at least 0.1, at least 0.15, at least 0.2, at least 0.25, at least 0.3, at least 0.35, at least 0.4, at least 0.45, at least 0.5, at least 0.6, at least 0.7, at least 0.8, at least 0.9, 1 or less, 0.9 or less, 0.8 or less, 0.7 or less, 0.6 or less, 0.5 or less, 0.45 or less, 0.4 or less, 0.35 or less, 0.3 or less, 0.25 or less, 0.2 or less, 0.15 or less, 0.1 or less, or any range formed therefrom, based on 100 pbw of a sum total of KNO₃ and NaNO₃, if present. For example, in some aspects, a molten salt bath comprises a lithium ion buffer in an amount (pbw) of 0.05-1, 0.05-0.9, 0.05-0.8, 0.05-0.7, 0.05-0.6, 0.05-0.5, 0.05-0.4, 0.05-0.3, 0.05-0.2, 0.05-0.1, 0.1-1, 0.1-0.9, 0.1-0.8, 0.1-0.7, 0.1-0.6, 0.1-0.5, 0.1-0.4, 0.1-0.3, 0.1-0.2, 0.2-1, 0.2-0.9, 0.2-0.8, 0.2-0.7, 0.2-0.6, 0.2-0.5, 0.2-0.4, 0.2-0.3, 0.3-1, 0.3-0.9, 0.3-0.8, 0.3-. 0.7, 0.3-0.6, 0.3-0.5, 0.3-0.4, 0.4-1, 0.4-0.9, 0.4-0.8, 0.4-0.7, 0.4-0.6, 0.4-0.5, 0.5-1, 0.5-0.9, 0.5-0.8, 0.5-0.7, 0.5-0.6, 0.6-1, 0.6-0.9, 0.6-0.8, 0.6-0.7, 0.7-1, 0.7-0.9, 0.7-0.8, 0.8-1, 0.8-0.9, or 0.9-1, based on 100 pbw of a sum total of KNO₃ and NaNO₃, if present. In particular, in some aspects, a molten salt bath comprises a lithium ion buffer in an amount (pbw) of 0.05-0.5, 0.1-0.4, 0.1-0.3, or 0.2-0.4, based on 100 pbw of a sum total of KNO₃ and NaNO₃, if present. In some aspects of the approximately weakly alkaline pH method, additional lithium ion buffer is not added, other than the original lithium ion buffer of the first contacting step (i.e., the pre-load of lithium ion buffer). In other words, in some aspects, lithium ion buffer is initially added as a pre-load to the molten salt bath of the first contacting step, the bath is regenerated with pH modifier and lithium ion scavenger to form a regenerated molten salt bath, and the a second contacting step is performed without adding any additional lithium ion buffer (only the original amount of lithium ion buffer pre-loaded for the first contacting step is still present). In some aspects, additional cycles may be performed, and generally no additional lithium ion buffer is added except for the very first cycle. However, in some aspects, it may become desirable to add additional lithium ion buffer at some point, for example, if the originally preloaded amount of lithium ion buffer falls below a certain amount such that it is not able to perform its buffer function.

In the approximately neutral pH method, the target pH range is, for example 5-9, 5-8.5, 5-8, 5-7.5, 5-7, 5-6.5, 5-6, 5-5.5, 5.5-9, 5.5-8.5, 5.5-8, 5.5-7.5, 5.5-7, 5.5-6.5, 5.5-6, 6-9, 6-8.5, 6-8, 6-7.5, 6-7, 6-6.5, 6.5-9, 6.5-8.5, 6.5-8, 6.5-7.5, 6.5-7, 7-9, 7-8.5, 7-8, 7-7.5, 7.5-9, 7.5-8.5, 7.5-8, 8-9, 8-8.5, or 8.5-9. In particular, in some aspects, the target pH range in the approximately neutral pH method is 6-9, 5.5-7.5, 6-7, 6-8, or 6-7.5.

In the approximately weakly alkaline pH method, the target pH range is, for example, 8.5-12, 8.5-11.5, 8.5-11, 8.5-10.5, 8.5-10, 8.5-9.5, 8.5-9, 9-12, 9-11.5, 9-11, 9-10.5, 9-10, 9-9.5, 9.5-12, 9.5-11.5, 9.5-11, 9.5-10.5, 9.5-10, 10-12, 10-11.5, 10-11, 10-10.5, 10.5-12, 10.5-11.5, 10.5-11, 11-12, 11-11.5, or 11.5-12. In particular, in some aspects, the target pH range in the approximately weakly alkaline pH method is 8.5-11, 9-11, 9.5-11, or 10-11.

In some aspects, the pH modifier is any suitable pH modifier that can adjust the pH to a desired target range. In some aspects, the pH modifier is silicic acid, metasilicic acid, disilicate, ortho silicic acid, pyrosilicate, B₂O₃, Al₂O₃, or any combination thereof.

In some aspects, the amount of pH modifier is less important than achieving a particular target pH. In other words, the amount of pH modifier is additive in sufficient amount to achieve a target pH. However, in some aspects it is useful to specify the amount. For example, when the pH modifier is silicic acid, the amount (wt. %, based on 100 wt. % of a sum total of NaNO₃ and KNO₃, if present) in the molten salt bath (and/or regenerated molten salt bath) is typically at least 0.01, at least 0.05, at least 0.1, at least 0.15, at least 0.2, at least 0.25, at least 0.3, at least 0.35, at least 0.4, at least 0.45, 0.5 or less, 0.45 or less, 0.4 or less, 0.35 or less, 0.3 or less, 0.25 or less, 0.2 or less, 0.15 or less, 0.1 or less, 0.05 or less, or any range formed therefrom. For example, in some aspects, the amount (wt. %) silicic acid is 0.01-0.5, 0.01-0.45, 0.01-0.4, 0.01-0.35, 0.01-0.3, 0.01-0.25, 0.01-0.2, 0.01-0.15, 0.01-0.1, 0.01-0.05, 0.05-0.5, 0.05-0.45, 0.05-0.4, 0.05-0.35, 0.05-0.3, 0.05-0.25, 0.05-0.2, 0.05-0.15, 0.05-0.1, 0.1-0.5, 0.1-0.45, 0.1-0.4, 0.1-0.35, 0.1-0.3, 0.1-0.25, 0.1-0.2, 0.1-0.15, 0.15-0.5, 0.15-0.45, 0.15-0.4, 0.15-0.35, 0.15-0.3, 0.15-0.25, 0.15-0.2, 0.2-0.5, 0.2-0.45, 0.2-0.4, 0.2-0.35, 0.2-0.3, 0.2-0.25, 0.25-0.5, 0.25-0.45, 0.25-0.4, 0.25-0.35, 0.25-0.3, 0.3-0.5, 0.3-0.45, 0.3-0.4, 0.3-0.35, 0.35-0.5, 0.35-0.45, 0.35-0.4, 0.4-0.5, 0.4-0.45, or 0.45-0.5. In particular, in some aspects, the amount (wt. %) of silicic acid is 0.01-0.5, 0.05-0.3, or 0.05-0.2. In some aspects, a method is performed over multiple cycles of contacting, pH adjusting, and lithium ion scavenging, and silicic acid is added after each contacting step (i.e., as a pH modifier) either prior to, concurrently along with, or after the lithium ion scavenging step.

In some aspects, the target dissolved lithium ion concentration (ppm), based on 100 wt. % of a sum total of NaNO₃ and KNO₃, if present, is at least 100, at least 115, at least 120, at least 140, at least 150, at least 160, at least 180, at least 200, at least 220, at least 240, at least 250, at least 260, at least 280, 300 or less, 280 or less, 260 or less, 250 or less, 240 or less, 220 or less, 200 or less, 180 or less, 160 or less, 150 or less, 140 or less, 120 or less, 115 or less, or any range formed therefrom. For example, in some aspects, the target dissolved lithium ion concentration (ppm), based on 100 wt. % of a sum total of NaNO₃ and KNO₃, if present, is 100-300, 100-280, 100-260, 100-250, 100-240, 100-220, 100-200, 100-180, 100-160, 100-150, 100-140, 100-120, 100-115, 100-110, 115-300, 115-280, 115-260, 115-250, 115-240, 115-220, 115-200, 115-180, 115-160, 115-150, 115-140, 115-120, 120-300, 120-280, 120-260, 120-250, 120-240, 120-220, 120-200, 120-180, 120-160, 120-150, 120-140, 140-300, 140-280, 140-260, 140-250, 140-240, 140-220, 140-200, 140-180, 140-160, 140-150, 150-300, 150-280, 150-260, 150-250, 150-240, 150-220, 150-200, 150-180, 150-160, 160-300, 160-280, 160-260, 160-250, 160-240, 160-220, 160-200, 160-180, 160-180, 180-300, 180-280, 180-260, 180-250, 180-240, 180-220, 180-200, 200-300, 200-280, 200-260, 200-250, 200-240, 200-220, 220-300, 220-280, 220-260, 220-250, 220-240, 240-300, 240-280, 240-260, 240-250, 250-300, 250-280, 250-260, 260-300, 260-280, or 280-300. In particular, in some aspects, the target dissolved lithium concentration (ppm), based on 100 wt. % of a sum total of NaNO₃ and KNO₃, if present, is 115-250, 120-250, 115-200, or 120-220. The relevance of keeping the dissolved lithium ion concentration within a target range is described in more detail elsewhere herein, particularly in the Examples. If the lithium ion concentration is too low when performing the methods herein (e.g., below 115 ppm or 110 ppm) and/or resulting glass-ceramic articles contain a low index layer on their surface (e.g., indicated by a blurry/hazy surface), then additional lithium ions can be added if desired, e.g., as LiNO₃ in increments of 20 ppm LiNO₃, until the blurriness/haziness resolves and/or the lithium ion concentration is within a target range (e.g., 110-250 ppm).

In some aspects, a second contacting step is performed, comprising contacting a second substrate with the regenerated molten salt bath, whereby (1) lithium ions diffuse from the second glass-ceramic substrate into the regenerated molten salt bath, and (2) at least one of sodium and potassium ions diffuse from the regenerated molten salt bath into the second glass-ceramic substrate, thereby forming a second glass-ceramic article. This step is analogous to the first contacting step, except a different substrate is ion-exchanged, and the ion-exchange happens in a regenerated molten salt bath. As described elsewhere herein, however, when multiple runs are performed whereby a molten salt bath is regenerated periodically according to the methods herein, and then substrates are ion-exchanged in the regenerated baths, then the “first contacting step” is equivalent to a regenerated bath.

In some aspects, an article that has been ion-exchanged is removed from the molten salt bath prior to regenerating the bath. In this regard, in some aspects, the first contacting step comprises immersing the substrate in the molten salt bath, and the method further comprises, after the first contacting step but before the lithium ion scavenging step, removing the resulting ion-exchanged article from the molten salt bath. In some aspects, an article that has been ion-exchanged is left in the molten salt bath during regeneration, or the article is removed as the molten salt bath is being regenerated.

In some aspects, an article that has been ion-exchanged is not subjected to a mechanical polishing step sufficient to mechanically abrade at least a portion of a surface thereof in a manner that is sufficient to remove at least a portion of a line defect and/or a low index layer, if present. In this regard, when conventional methods are employed in the art to ion exchange a substrate, the resulting ion-exchanged article can have certain defects present (e.g., low index layer, line defects, staining, and so forth). To remove such defects, it is typically necessary to mechanical polish the articles. However, as described elsewhere herein, employing the methods herein generally results in an ion-exchanged article that does not have such defects present, and therefore there is no need to perform such a mechanical polishing step.

In some aspects, the lithium ion scavenger comprises a metasilicate, a sodium-containing glass-based material having a different composition than the substrate that is subjected to the first contacting step, or any combination thereof. In some aspects, the lithium ion scavenger comprises the metasilicate. In some aspects, the metasilicate is sodium metasilicate, potassium metasilicate, or a combination thereof. In some aspects, the lithium ion scavenger comprises the sodium-containing glass-based material having a different composition than the substrate that is subjected to the first contacting step. Without wishing to be bound by theory, it is believed that such a sodium-containing glass is effective in acting as a lithium ion scavenger because the lithium in the molten salt bath diffuses into the sodium-containing glass, effectively soaking up at least a portion of the lithium ions in the molten salt bath. In some aspects, suitable sodium-containing glass-based material compositions for lithium ion scavenger generally comprise 30-85 mol. % SiO₂, 2-20 mol. % Al₂O₃, 10-60 mol. % Na₂O, 0-3 mol. % K₂O, 0-10 mol. % MgO, 0-10 mol. % CaO, and 0-10 mol. % SrO, and have any suitable size and shape, as described in U.S. Patent Application Publication 2024/0182352, hereby incorporated by reference in its entirety for all purposes. For example, the sodium-containing glass-based material can be in the form of chunks (e.g., shards), powder, or a combination thereof. In some aspects, the sodium-containing glass-based material can have a size (e.g., average diameter) in the range of a few millimeters to a few centimeters. In some aspects, the powder can have an average particle size of from 1-100 microns (e.g., 10-90, 20-80, 30-70, 40-60 microns, or any range formed from any of these endpoints). In some aspects, the chunks can have an average particle size of from 50-10000 microns (e.g., 100-9000, 300-8000, 400-7000, 500-6000, 600-5000, 700-4000, 800-3000, 900-2000, 1000-1500 microns, or any range formed from any of these endpoints). Unless otherwise specified, average particle size is measured using standard sieve techniques to separate particle sizes after ball milling (for larger particles) and jet milling (for smaller particles), which are suitable methods for reducing the particle size of a sodium-containing glass-based material. There is some overlap between the “powder” and “chunk” ranges, because the particle types are correlated with preferred methods of use for the particle type, i.e., remaining in the bath vs. removal. But, powders may be removed from the bath and chunks may be left in.

In some aspects, the lithium ion scavenger is present in the molten salt bath in any suitable amount. In some aspects, the lithium ion scavenger is present in the molten salt bath in an amount (parts by weight (pbw)) of at least 0.2, at least 0.4, at least 0.6, at least 0.8, at least 1, at least 1.2, at least 1.4, at least 1.6, at least 1.8, 2 or less, 1.8 or less, 1.6 or less, 1.4 or less, 1.2 or less, 1 or less, 0.8 or less, 0.6 or less, 0.4 or less, or any range formed therefrom. For example, in some aspects, the lithium ion scavenger is present in the molten salt bath in an amount (parts by weight (pbw)) of 0.2-2, 0.2-1.8, 0.2-1.6, 0.2-1.4, 0.2-1.2, 0.2-1, 0.2-0.8, 0.2-0.6, 0.2-0.4, 0.4-2, 0.4-1.8, 0.4-1.6, 0.4-1.4, 0.4-1.2, 0.4-1, 0.4-0.8, 0.4-0.6, 0.6-2, 0.6-1.8, 0.6-1.6, 0.6-1.4, 0.6-1.2, 0.6-1, 0.6-1.8, 0.8-2, 0.8-1.8, 0.8-1.6, 0.8-1.4, 0.8-1.2, 0.8-1, 1-2, 1-1.8, 1-1.6, 1-1.4, 1-1.2, 1.2-2, 1.2-1.8, 1.2-1.6, 1.2-1.4, 1.4-2, 1.4-1.8, 1.4-1.6, 1.6-2, 1.6-1.8, or 1.8-2, based on 100 pbw of a sum total of NaNO₃ and KNO₃. In this regard, the lithium ion scavenger is added by superaddition relative to the base composition of the molten salt bath. In some aspects, the lithium ion scavenger is present in an amount of 0.2-1, 0.4-1, 0.2-1.2, 0.4-1.6, or 0.4-0.8, based on 100 pbw of a sum total of NaNO₃ and KNO₃.

In some aspects, during the lithium ion scavenging step, the lithium ion scavenger is added directly to the molten salt bath (e.g., without any containment vessel between the lithium ion scavenger and the bulk molten salt bath). In some aspects, during the lithium ion scavenging step, the lithium ion scavenger is at least partially (e.g., completely) contained within a perforated vessel (e.g., a tea bag style basket). In some aspects, during the lithium ion scavenging step, the lithium ion scavenger is directly added to the molten salt bath, and also at least partially contained within a perforated vessel.

In some aspects, the lithium ion scavenging step is performed at any suitable conditions that are effective to scavenge lithium ions. Generally, the lithium ion scavenging steps herein can employ the use of “first,” “second,” and so forth to distinguish two different lithium ion scavenging steps. In some aspects, the lithium ion scavenging step is performed at a temperature (° C.) of at least 450, at least 475, at least 500, at least 525, at least 550, at least 575, 600 or less, 575 or less, 550 or less, 525 or less, 500 or less, 475 or less, or any range formed therefrom. For example, in some aspects, the lithium ion scavenging step is performed at a temperature (C) of 450-600, 450-575, 450-550, 450-525, 450-500, 450-475, 475-600, 475-575, 475-550, 475-525, 475-500, 500-600, 500-575, 500-550, 500-525, 525-600, 525-575, 525-550, 550-600, 550-575, or 575-600. In particular, in some aspects, the lithium ion scavenging step is performed at a temperature (C) of 450-600, 475-550, or 500-575.

In some aspects, the lithium ion scavenging step is performed for a time period (hr) of at least 1, at least 1.5, at least 2, at least 2.5, at least 3, at least 3.5, at least 4, at least 4.5, at least 5, at least 5.5, at least 6, at least 6.5, at least 7, at least 7.5, 8 or less, 7.5 or less, 7 or less, 6.5 or less, 6 or less, 5.5 or less, 5 or less, 4.5 or less, 4 or less, 3.5 or less, 3 or less, 2.5 or less, 2 or less, 1.5 or less, or any range formed therefrom. For example, in some aspects, the lithium ion scavenging step is performed for a time period (hr) of 1-8, 1-7.5, 1-7, 1-6.5, 1-6, 1-5.5, 1-5, 1-4.5, 1-4, 1-3.5, 1-3, 1-2.5, 1-2, 1-1.5, 1.5-8, 1.5-7.5, 1.5-7, 1.5-6.5, 1.5-6, 1.5-5.5, 1.5-5, 1.5-4.5, 1.5-4, 1.5-3.5, 1.5-3, 1.5-2.5, 1.5-2, 2-8, 2-7.5, 2-7, 2-6.5, 2-6, 2-5.5, 2-5, 2-4.5, 2-4, 2-3.5, 2-3, 2-2.5, 2.5-8, 2.5-7.5, 2.5-7, 2.5-6.5, 2.5-6, 2.5-5.5, 2.5-5, 2.5-4.5, 2.5-4, 2.5-3.5, 2.5-3, 3-8, 3-7.5, 3-7, 3-6.5, 3-6, 3-5.5, 3-5, 3-4.5, 3-4, 3-3.5, 3.5-8, 3.5-7.5, 3.5-7, 3.5-6.5, 3.5-6, 3.5-5.5, 3.5-5, 3.5-4.5, 3.5-4, 4-8, 4-7.5, 4-7, 4-6.5, 4-6, 4-5.5, 4-5, 4-4.5, 4.5-8, 4.5-7.5, 4.5-7, 4.5-6.5, 4.5-6, 4.5-5.5, 4.5-5, 5-8, 5-7.5, 5-7, 5-6.5, 5-6, 5-5.5, 5.5-8, 5.5-7.5, 5.5-7, 5.5-6.5, 5.5-6, 6-8, 6-7.5, 6-7, 6-6.5, 6.5-8, 6.5-7.5, 6.5-7, 7-8, 7-7.5, or 7.5-8. In particular, in some aspects, the lithium ion scavenging step is performed for a time period (hr) of 1-8, 1.5-6.5, 2.5-5.5, or 3-6.

In some aspects, a contacting step (e.g., the first contacting step) is performed at any suitable conditions that are effective to create a desired degree of compressive stress, depth of layer, central tension, or any combination thereof. Generally, the contacting steps herein are ion exchange steps, and the use of “first,” “second,” and so forth is used to distinguish two different contacting steps. In some aspects, the contacting step (e.g., first contacting step) is performed at a temperature (° C.) of at least 450, at least 475, at least 500, at least 525, at least 530, at least 550, at least 575, 600 or less, 575 or less, 550 or less, 530 or less, 525 or less, 500 or less, 475 or less, or any range formed therefrom. For example, in some aspects, the contacting step (e.g., first contacting step) is performed at a temperature (° C.) of 450-600, 450-575, 450-550, 450-530, 450-525, 450-500, 450-475, 475-600, 475-575, 475-550, 475-530, 475-525, 475-500, 500-600, 500-575, 500-550, 500-530, 500-525, 525-600, 525-575, 525-550, 525-530, 530-600, 530-575, 530-550, 550-600, 550-575, or 575-600. In particular, in some aspects, the contacting step (e.g., first contacting step) is performed at a temperature (° C.) of 450-600, 450-530, 450-550, 475-550, or 500-575.

In some aspects, a contacting step (e.g., first contacting step) is performed for a time period (hr) of at least 1, at least 2, at least 3, at least 4, at least 5, at least 6, at least 7, at least 8, at least 9, at least 10, at least 11, 12 or less, 11 or less, 10 or less, 9 or less, 8 or less, 7 or less, 6 or less, 5 or less, 4 or less, 3 or less, 2 or less, or any range formed therefrom. For example, in some aspects, the contacting step (e.g., first contacting step) is performed for a time period (hr) of 1-12, 1-11, 1-10, 1-9, 1-8, 1-7, 1-6, 1-5, 1-4, 1-3, 1-2, 2-12, 2-11, 2-10, 2-9, 2-8, 2-7, 2-6, 2-5, 2-4, 2-3, 3-12, 3-11, 3-10, 3-9, 3-8, 3-7, 3-6, 3-5, 3-4, 4-12, 4-11, 4-10, 4-9, 4-8, 4-7, 4-6, 4-5, 5-12, 5-11, 5-10, 5-9, 5-8, 5-7, 5-6, 6-12, 6-11, 6-10, 6-9, 6-8, 6-7, 7-12, 7-11, 7-10, 7-9, 7-8, 8-12, 8-11, 8-10, 8-9, 9-12, 9-11, 9-10, 10-12, 10-11, or 11-12. In particular, in some aspects, a contacting step (e.g., first contacting step) is performed for a time period (hr) of 1-12, 2-10, 4-9, or 3-8.

In some aspects, any suitable number of lithium ion scavenging steps and contacting steps are conducted. For example, in some aspects, the one, two, three, four, five, six, seven, or eight lithium ion scavenging steps are conducted. In some aspects, the one, two, three, four, five, six, seven, or eight contacting steps are conducted. In some aspects, a lithium ion scavenging step is conducted after a contacting step (e.g., a contacting step is where lithium ions diffuse out of a substrate and into the molten salt bath, and ions in the molten salt bath diffuse into the substrate). In some aspects, the lithium ion scavenging step and contacting steps are conducted sequentially or concurrently. In some aspects, the lithium ion scavenging step and contacting steps are conducted sequentially, and the lithium ion scavenging step follows each contacting step. In some aspects, the lithium ion scavenging step is performed periodically, such as after every other contacting step or after every third contacting step.

In some aspects of the approximately neutral pH method, the molten salt bath is free or substantially free of a lithium ion buffer (e.g., trisodium phosphate (TSP)), and typically a lithium precipitating additive (e.g., TSP) is not used to regenerate the baths. In this regard, in some aspects of the approximately neutral pH method, the molten salt batch comprises 0.1 wt. % or less of TSP, 0.05 wt. % or less of TSP, or 0.01 wt. % or less of TSP, based on total weight of NaNO₃ and KNO₃, if present. In some aspects of the approximately neutral pH method, the molten salt batch comprises 0-0.1 wt. %, 0-0.05 wt. %, or 0-0.01 wt. % of TSP, based on total weight of NaNO₃ and KNO₃.

In some aspects, a substrate is subjected to a contacting step (e.g., ion-exchanged) as a single part. In some aspects, a plurality of substrates is subjected to a contacting step (e.g., ion-exchanged) as a single sheet that contains perforations, allowing the sheet to be broken into single parts along the perforation lines—the perforations also allow infiltration of the molten salt bath, thereby strengthening edges of the parts without the need for a subsequent contacting step after separation along the perforations. In some aspects, a plurality of substrates is subjected to a contacting step (e.g., ion-exchanged) as a plurality of individual parts. In such an aspect, the loading density of the parts can be any suitable value (m²/kg), such as 0.012-0.016, 0.013-0.016, 0.014-0.016, 0.015-0.016, or 0.016.

In some aspects the substrate is or comprises a glass, a glass-ceramic, or a ceramic. In some aspects, the substrate is or comprises a glass-ceramic. It is believed the methods herein are particularly effective in conjunction with glass-ceramic substrates given that glass-ceramics in particular are prone to formation of a low index layer and line defects. However, it is conceivable that other types of substrates, such as glass or ceramic, may also benefit from the methods herein. In some aspects, the substrates are ion-exchangeable. In some aspects, the glass-ceramic substrate comprises aluminosilicate. Note that substrates can be differentiated herein in terms of “first,” “second,” “third,” and so forth, so as to clearly define the methods (e.g., the method may be performed multiple times, and each iteration of the method may refer to a different numbered substrate so as to differentiate such substrates).

In some aspects, a substrate generally is a glass, glass-ceramic, or ceramic. Prior to ion exchange, the substrate has a particular composition that is generally uniform throughout, within a certain depth of a surface and at the center of the substrate. During ion-exchange, ions diffuse into and out of the surface of the substrate generally up to a depth of layer (DOL), and therefore the original composition of the substrate may be slightly different from the composition that is present within the DOL; however, the original composition of the substrate is typically the same as the composition present at the center of an ion-exchanged article, since the ion exchange process does not affect the composition at the center of the article. The composition of the original substrate is generally disclosed herein, but it is to be understood that this composition also applies to the composition at the center of an ion-exchanged article. If a substrate is a glass-ceramic that has certain crystal phases present prior to ion exchange, then the resulting article after ion-exchange will generally have those same crystal phases present in the same proportions.

In some aspects, a substrate and/or article comprises a petalite crystalline phase. In some aspects, a substrate and/or article comprises a lithium silicate crystalline phase. In some aspects, a substrate and/or article comprises both a petalite crystalline phase and a lithium silicate crystalline phase. In some aspects, a sum total of the petalite crystalline phase and the lithium silicate crystalline phase is a higher weight percentage than a sum total of all other crystalline phases, if any, present in the substrate and/or article. In some aspects, the lithium silicate crystalline phase is or comprises lithium disilicate. The crystal identities and content can be measured by known techniques employing X-ray diffraction (XRD).

In some aspects, the substrate and/or article has an average transmittance greater than 85% (e.g., greater than 90%, greater than 95%, or greater than 99%) over the wavelength range from 400 nm to 1000 nm for a glass-ceramic article thickness of 1 mm.

In some aspects, the substrate and/or article has a thickness (mm) of 0.1-5, 0.1-4.5, 0.1-4, 0.1-3.5, 0.1-3, 0.1-2.5, 0.1-2, 0.1-1.5, 0.1-1, 0.1-0.8, 0.1-0.6, 0.1-0.4, 0.1-0.2, 0.2-5, 0.2-4.5, 0.2-4, 0.2-3.5, 0.2-3, 0.2-2.5, 0.2-2, 0.2-1.5, 0.2-1, 0.2-0.8, 0.2-0.6, 0.2-0.4, 0.4-5, 0.4-4.5, 0.4-4, 0.4-3.5, 0.4-3, 0.4-2.5, 0.4-2, 0.4-1.5, 0.4-1, 0.4-0.8, 0.4-0.6, 0.6-5, 0.6-4.5, 0.6-4, 0.6-3.5, 0.6-3, 0.6-2.5, 0.6-2, 0.6-1.5, 0.6-1, 0.6-0.8, 0.8-5, 0.8-4.5, 0.8-4, 0.8-3.5, 0.8-3, 0.8-2.5, 0.8-2, 0.8-1.5, 0.8-1, 1-5, 1-4.5, 1-4, 1-3.5, 1-3, 1-2.5, 1-2, 1-1.5, 1.5-5, 1.5-4.5, 1.5-4, 1.5-3.5, 1.5-3, 1.5-2.5, 1.5-2, 2-5, 2-4.5, 2-4, 2-3.5, 2-3, 2-2.5, 2.5-5, 2.5-4.5, 2.5-4, 2.5-3.5, 2.5-3, 3-5, 3-4.5, 3-4, 3-3.5, 3.5-5, 3.5-4.5, 3.5-4, 4-5, 4-4.5, or 4.5-5. In particular, in some aspects, the substrate and/or article has a thickness (mm) of 0.1-5, 0.1-2, 0.1-1, 0.2-1.4, or 0.4-1.

In some aspects, a substrate and/or article comprises grains and the grains have a longest dimension of less than 100 nm (e.g., 1-100 nm, 10-90 nm, 20-80 nm, 30-70 nm, 40-60 nm, or any range formed from any of these numbers, such as 1-80 nm, 10-70 nm, and so forth).

In some aspects, a substrate, article and/or center of the article comprises SiO₂, Al₂O₃, Li₂O, CaO, P₂O₅, and ZrO₂, and optionally one or more of Na₂O, K₂O, and HfO₂. In some aspects, a substrate comprises SiO₂, Al₂O₃, Li₂O, CaO, P₂O₅, ZrO₂, Na₂O, K₂O, and HfO₂. In some aspects, a substrate comprises (wt. %) 55-80 SiO₂, 2-20 wt. % Al₂O₃, 5-20 wt. % Li₂O, >0-5 wt. % CaO, >0-6 wt. % P₂O₅, 0.2-15 wt. % ZrO₂, 0-5 wt. % Na₂O, 0-5 wt. % K₂O, and ≤3 wt. % HfO₂, wherein ZrO₂ wt. %+P₂O₅ wt. %>1 wt. %.

In some aspects, a substrate, article and/or center of the article comprises SiO₂. In some aspects, the SiO₂ is present in an amount (wt. %) of at least 55, at least 56, at least 58, at least 60, at least 62, at least 64, at least 66, at least 68, at least 70, at least 72, at least 74, at least 76, at least 78, 80 or less, 78 or less, 76 or less, 74 or less, 72 or less, 70 or less, 68 or less, 66 or less, 64 or less, 62 or less, 60 or less, 58 or less, 56 or less, or any range formed therefrom. For example, in some aspects, the SiO₂ is present in an amount (wt. %) of 55-80, 55-78, 55-76, 55-74, 55-72, 55-70, 55-68, 55-66, 55-64, 55-62, 55-60, 55-58, 55-56, 56-80, 56-78, 56-76, 56-74, 56-72, 56-70, 56-68, 56-66, 56-64, 56-62, 56-60, 56-58, 58-80, 58-78, 58-76, 58-74, 58-72, 58-70, 58-68, 58-66, 58-64, 58-62, 58-60, 60-80, 60-78, 60-76, 60-74, 60-72, 60-70, 60-68, 60-66, 60-64, 60-62, 62-80, 62-78, 62-76, 62-74, 62-72, 62-70, 62-68, 62-66, 62-64, 64-80, 64-78, 64-76, 64-74, 64-72, 64-70, 64-68, 64-66, 66-80, 66-78, 66-76, 66-74, 66-72, 66-70, 66-68, 68-80, 68-78, 68-76, 68-74, 68-72, 68-70, 70-80, 70-78, 70-76, 70-74, 70-72, 72-80, 72-78, 72-76, 72-74, 74-80, 74-76, 76-80, 76-78, or 78-80. In particular, in some aspects, SiO₂ is present in an amount (wt. %) 55-80, 68-78, or 64-76.

In some aspects, a substrate, article and/or center of the article comprises Al₂O₃. In some aspects, the Al₂O₃ is present in an amount (wt. %) of at least 2, at least 4, at least 6, at least 8, at least 10, at least 12, at least 14, at least 16, at least 18, 20 or less, 18 or less, 16 or less, 14 or less, 12 or less, 10 or less, 8 or less, 6 or less, 4 or less, or any range formed therefrom. For example, in some aspects, Al₂O₃ is present in an amount (wt. %) of 2-20, 2-18, 2-16, 2-14, 2-12, 2-10, 2-8, 2-6, 2-4, 4-20, 4-18, 4-16, 4-14, 4-12, 4-10, 4-8, 4-6, 6-20, 6-18, 6-16, 6-14, 6-12, 6-10, 6-8, 8-20, 8-18, 8-16, 8-14, 8-12, 8-10, 10-20, 10-18, 10-16, 10-14, 10-12, 12-20, 12-18, 12-16, 12-14, 14-20, 14-18, 14-16, 16-20, 16-18, or 18-20. In particular, in some aspects, Al₂O₃ is present in an amount (wt. %) of 2-20, 4-18, 4-12, or 2-10.

In some aspects, a substrate, article and/or center of the article comprises Li₂O. In some aspects, the Li₂O is present in an amount (wt. %) of at least 5, at least 6, at least 8, at least 10, at least 12, at least 14, at least 16, at least 18, 20 or less, 18 or less, 16 or less, 14 or less, 12 or less, 10 or less, 8 or less, 6 or less, or any range formed therefrom. For example, in some aspects, Li₂O is present in an amount (wt. %) of 5-20, 5-18, 5-16, 5-14, 5-12, 5-10, 5-8, 5-6, 6-20, 6-18, 6-16, 6-14, 6-12, 6-10, 6-8, 8-20, 8-18, 8-16, 8-14, 8-12, 8-10, 10-20, 10-18, 10-16, 10-14, 10-12, 12-20, 12-18, 12-16, 12-14, 14-20, 14-18, 14-16, 16-20, 16-18, or 18-20. In particular, in some aspects, Li₂O is present in an amount (wt. %) of 5-20, 10-20, 6-16, 8-18, or 8-14.

In some aspects, a substrate, article and/or center of the article comprises Na₂O. In some aspects, the Na₂O is present in an amount (wt. %) of 0, >0, at least 1, at least 2, at least 3, at least 4, 5 or less, 4 or less, 3 or less, 2 or less, 1 or less, or any range formed therefrom. For example, in some aspects, Na₂O is present in an amount (wt. %) of 0-5, 0-4, 0-3, 0-2, 0-1, >0-5, >0-4, >0-3, >0-2, >0-1, 1-5, 1-4, 1-3, 1-2, 2-5, 2-4, 2-3, 3-5, 3-4, or 4-5. In particular, in some aspects, Na₂O is present in an amount (wt. %) of 0-5, >0-5, >0-1, or >0-3.

In some aspects, a substrate, article and/or center of the article comprises K₂O. In some aspects, the K₂O is present in an amount (wt. %) of 0, >0, at least 1, at least 2, at least 3, at least 4, 5 or less, 4 or less, 3 or less, 2 or less, 1 or less, or any range formed therefrom. For example, in some aspects, K₂O is present in an amount (wt. %) of 0-5, 0-4, 0-3, 0-2, 0-1, >0-5, >0-4, >0-3, >0-2, >0-1, 1-5, 1-4, 1-3, 1-2, 2-5, 2-4, 2-3, 3-5, 3-4, or 4-5. In particular, in some aspects, K₂O is present in an amount (wt. %) of 0-5, >0-5, >0-1, or >0-3.

In some aspects, a substrate, article and/or center of the article comprises CaO. In some aspects, the CaO is present in an amount (wt. %) of 0, >0, at least 1, at least 2, at least 3, at least 4, 5 or less, 4 or less, 3 or less, 2 or less, 1 or less, or any range formed therefrom. For example, in some aspects, CaO is present in an amount (wt. %) of 0-5, 0-4, 0-3, 0-2, 0-1, >0-5, >0-4, >0-3, >0-2, >0-1, 1-5, 1-4, 1-3, 1-2, 2-5, 2-4, 2-3, 3-5, 3-4, or 4-5. In particular, in some aspects, CaO is present in an amount (wt. %) of 0-5, >0-5, >0-1, or >0-3.

In some aspects, a substrate, article and/or center of the article comprises P₂O₅. In some aspects, the P₂O₅ is present in an amount (wt. %) of 0, >0, at least 1, at least 2, at least 3, at least 4, at least 5, 6 or less, 5 or less, 4 or less, 3 or less, 2 or less, 1 or less, or any range formed therefrom. For example, in some aspects, P₂O₅ is present in an amount (wt. %) of 0-6, 0-5, 0-4, 0-3, 0-2, 0-1, >0-6, >0-5, >0-4, >0-3, >0-2, >0-1, 1-6, 1-5, 1-4, 1-3, 1-2, 2-6, 2-5, 2-4, 2-3, 3-6, 3-5, 3-4, 4-6, 4-5, or 5-6. In particular, in some aspects, P₂O₅ is present in an amount (wt. %) of 0-6, >0-6, >0-4, >0-1, or >0-3.

In some aspects, a substrate, article and/or center of the article comprises ZrO₂. In some aspects, the ZrO₂ is present in an amount (wt. %) of 0, >0, at least 0.2, at least 0.5, at least 1, at least 2, at least 3, at least 4, at least 6, at least 8, at least 10, at least 12, at least 14, 15 or less, 14 or less, 12 or less, 10 or less, 8 or less, 6 or less, 4 or less, 3 or less, 2 or less, 1 or less, 0.5 or less, 0.2 or less, or any range formed therefrom. For example, in some aspects, ZrO₂ is present in an amount (wt. %) of 0-15, 0-14, 0-12, 0-10, 0-8, 0-6, 0-4, 0-3, 0-2, 0-1, 0-0.5, 0-0.2, >0-15, >0-14, >0-12, >0-10, >0-8, >0-6, >0-4, >0-3, >0-2, >0-1, >0-0.5, >0-0.2, 0.2-15, 0.2-14, 0.2-12, 0.2-10, 0.2-8, 0.2-6, 0.2-4, 0.2-3, 0.2-2, 0.2-1, 0.2-0.5, 0.5-15, 0.5-14, 0.5-12, 0.5-10, 0.5-8, 0.5-6, 0.5-4, 0.5-3, 0.5-2, 0.5-1, 1-15, 1-14, 1-12, 1-10, 1-8, 1-6, 1-4, 1-3, 1-2, 2-15, 2-14, 2-12, 2-10, 2-8, 2-6, 2-4, 2-3, 3-15, 3-14, 3-12, 3-10, 3-8, 3-6, 3-4, 4-15, 4-14, 4-12, 4-10, 4-8, 4-6, 6-15, 6-14, 6-12, 6-10, 6-8, 8-15, 8-14, 8-12, 8-10, 10-15, 10-14, 10-12, 12-15, 12-14, or 14-15. In particular, in some aspects, ZrO₂ is present in an amount (wt. %) of 0.2-15, 3-15, 1-10, or 2-12.

In some aspects, a substrate, article and/or center of the article comprises a sum total of ZrO₂+P₂O₅, which employs the wt. % amounts of each of ZrO₂ and P₂O₅. In some aspects, a sum of ZrO₂+P₂O₅ (wt. %) is 0, >0, at least 0.2, at least 0.5, at least 1, at least 2, at least 4, at least 6, at least 8, at least 10, at least 12, at least 14, at least 16, at least 18, at least 20, 22 or less, 20 or less, 18 or less, 16 or less, 14 or less, 12 or less, 10 or less, 8 or less, 6 or less, 4 or less, 2 or less, 1 or less, 0.5 or less, 0.2 or less, or any range formed therefrom. For example, in some aspects, a sum of ZrO₂+P₂O₅ (wt. %) is 0-22, 0-20, 0-18, 0-16, 0-14, 0-12, 0-10, 0-8, 0-6, 0-4, 0-2, 0-1, 0-0.5, 0-0.2, >0-22, >0-20, >0-18, >0-16, >0-14, >0-12, >0-10, >0-8, >0-6, >0-4, >0-2, >0-1, >0-0.5, >0-0.2, 0.2-22, 0.2-20, 0.2-18, 0.2-16, 0.2-14, 0.2-12, 0.2-10, 0.2-8, 0.2-6, 0.2-4, 0.2-2, 0.2-1, 0.2-0.5, 0.5-22, 0.5-20, 0.5-18, 0.5-16, 0.5-14, 0.5-12, 0.5-10, 0.5-8, 0.5-6, 0.5-4, 0.5-2, 0.5-1, 1-22, 1-20, 1-18, 1-16, 1-14, 1-12, 1-10, 1-8, 1-6, 1-4, 1-2, 2-22, 2-20, 2-18, 2-16, 2-14, 2-12, 2-10, 2-8, 2-6, 2-4, 4-22, 4-20, 4-18, 4-16, 4-14, 4-12, 4-10, 4-8, 4-6, 6-22, 6-20, 6-18, 6-16, 6-14, 6-12, 6-10, 6-8, 8-22, 8-20, 8-18, 8-16, 8-14, 8-12, 8-10, 10-22, 10-20, 10-18, 10-16, 10-14, 10-12, 12-22, 12-20, 12-18, 12-16, 12-14, 14-22, 14-20, 14-18, 14-16, 16-22, 16-20, 16-18, 18-22, 18-20, or 20-22. In particular, in some aspects, a sum of ZrO₂+P₂O₅ (wt. %) is at least 1, at least 3, 4-14, 2-12, or 6-12.

In some aspects, a substrate, article and/or center of the article comprises HfO₂. In some aspects, the HfO₂ is present in an amount (wt. %) of 0, >0, at least 0.1, at least 0.5, at least 1, at least 1.5, at least 2, at least 2.5, 3 or less, 2.5 or less, 2 or less, 1.5 or less, 1 or less, 0.5 or less, 0.2 or less, or any range formed therefrom. For example, in some aspects, HfO₂ is present in an amount (wt. %) of 0-3, 0-2.5, 0-2, 0-1.5, 0-1, 0-0.5, 0-0.2, >0-3, >0-3.5, >0-3, >0-2.5, >0-2, >0-1.5, >0-1, >0-0.5, >0-0.2, 0.2-3, 0.2-2.5, 0.2-2, 0.2-1.5, 0.2-1, 0.2-0.5, 0.5-3, 0.5-2.5, 0.5-2, 0.5-1.5, 0.5-1, 1-3, 1-2.5, 1-2, 1-1.5, 1.5-3, 1.5-2.5, 1.5-2, 2-3, 2-2.5, or 2.5-3. In particular, in some aspects, HfO₂ is present in an amount (wt. %) of >0-3, >0-1, or >0-0.5.

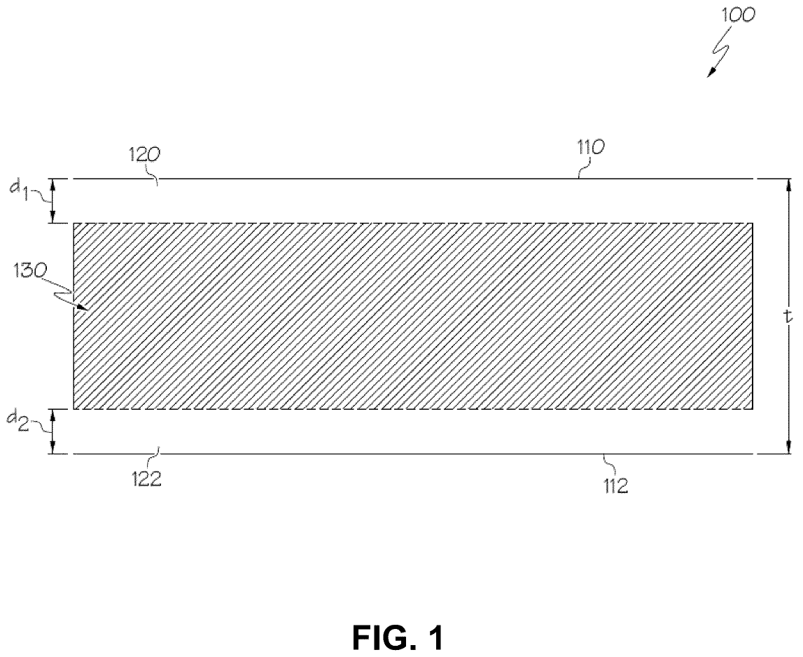

As mentioned elsewhere herein, the substrates described herein can be strengthened, such as by ion exchange, making an article that is damage resistant for applications such as, but not limited to, display covers or housings (e.g., for consumer electronic devices). With reference to FIG. 1, an article is depicted that has a first region under compressive stress (e.g., first and second compressive layers 120, 122 in FIG. 1) extending from the surface to a depth of compression (DOC) of the article and a second region (e.g., central region 130 in FIG. 1) under a tensile stress or central tension (CT) extending from the DOC into the central or interior region of the article. As used herein, DOC refers to the depth at which the stress within the article changes from compressive to tensile. At the DOC, the stress crosses from a positive (compressive) stress to a negative (tensile) stress and thus exhibits a stress value of zero.

According to the convention normally used in the art, compression or compressive stress is expressed as a negative (<0) stress and tension or tensile stress is expressed as a positive (>0) stress. Throughout this description, however, CS is expressed as a positive or absolute value—i.e., as recited herein, CS=|CS|. The compressive stress (CS) has a maximum at or near the surface of the article, and the CS varies with distance d from the surface according to a function. Referring again to FIG. 1, a first segment 120 extends from first primary surface 110 to a depth d₁ and a second segment 122 extends from second primary surface 112 to a depth d₂. Together, these segments define a compression or CS of article 100. The surface compressive stress (CS) may be measured using a scattered light polariscope (SCALP) technique or a refractive near field (RNF) technique known in the art. CS values provided herein are measured using a SCALP technique, unless otherwise specified. As used herein, the term “CSₖ” refers to the compressive stress at the depth of the knee (i.e., transition point) as measured by RNF.

The compressive stress of both primary surfaces (110, 112 in FIG. 1) is balanced by stored tension in the central region (130) of the article. The surface compressive stress (CS), maximum central tension (CT) and DOC values may be measured using a scattered light polariscope (SCALP) technique or a refractive near field (RNF) technique known in the art. The SCALP method or RNF method also may be used to determine the stress profile of the articles.

In some aspects, disclosed is an article (e.g., glass-ceramic article). In some aspects, the article is produced by the methods herein. In other aspects, the article can be produced by other methods. In some aspects, the article is produced by ion exchange in a regenerated molten salt bath. In some aspects, disclosed is an article comprising:
first and second primary surfaces, the first primary surface comprising a textured region, a void having an edge, or both the textured region and the void having the edge;
a first compressive stress layer extending from the first primary surface to a first depth of compression (DOC1) and a second compressive stress layer extending from the second primary surface to a second depth of compression (DOC2);
a central tension region extending from DOC1 to DOC2; and
at least one region that satisfies Equation 1:

$$\vert \frac{( {Ca}_{n} - {Ca}_{n \pm 1} )}{{Ca}_{n}} \vert \times 100 > 15 \% ; \qquad ( Equation 1 )$$

wherein Caₙ is an average normalized intensity of calcium in a first 50 nm region, Ca_{n±1} is an average normalized intensity of calcium in a second 50 nm region immediately adjacent to the first 50 nm region, both the first and second 50 nm regions are within a depth of 25 nm to 5000 nm from the first primary surface, and both Caₙ and Ca_{n±1} are measured by SIMS analysis;
wherein at least one of the textured region and the edge, if present, is substantially free of line defects; and
wherein at least one of the textured region and the edge, if present, is substantially free of a low index layer.

Referring to FIG. 1, disclosed is an article 100 comprising a first primary surface 110, second primary surface 112, a DOC1 represented by d₁, a DOC2 represented by d₂, and a central tension region 130 extending from DOC1 to DOC2 (e.g., the area between d₁ and d₂). A textured region, a void having an edge, or both (not depicted) can be present on the first 110 or second 112 primary surfaces.

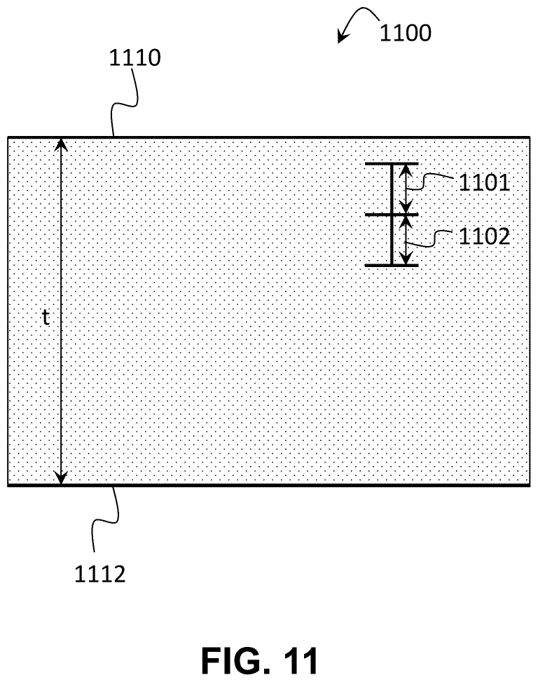

Referring to FIG. 11, which can be considered a simplified version of some aspects of FIG. 1, disclosed is a profile view of a simplified schematic diagram of an article with embellished features (not to scale) to illustrate certain concepts herein, particularly of Equation 1. In particular, article 1100 has a first primary surface 1110 and a second primary surface 1112 that defines a thickness t. Article 1100 has a first 50 nm region 1101 and a second 50 nm region 1102 immediately adjacent to the first 50 nm region 1101. As can be seen by this diagram, the first and second 50 nm regions are adjacent to one another, and these regions extend in a direction perpendicular to the first primary surface. While region 1101 is depicted at a shallower depth in article 1100 than region 1102, region 1101 could be at a deeper depth than region 1102, provided that both first and second 50 nm regions 1101 and 1102, respectively, are adjacent and within a depth of 25 nm to 5000 nm from the first primary surface 1110. The calcium contents in the first 50 nm region 1101 and second 50 nm region 1102 are measured, sliding shallower and/or deeper within the depth of 25 nm to 5000 nm from the first primary surface 1110, to determine whether Equation 1 can be satisfied. If it can be satisfied, it can reasonably be concluded that the first primary surface was not mechanically polished. If it cannot be satisfied, it can reasonably be concluded that the article has been mechanically polished. The reasons for these conclusions are discussed elsewhere herein. Note that, although FIG. 11 is discussed in terms of a primary surface, such measurements can also be performed on an edge of a void to determine whether mechanical polishing took place, and whether there are any line defects and/or low index layers present. The edges of a void typically are not mechanically polished. As a result, if the edge of a void meets Equation 1 and does not have line defects and/or low index layers present on the edge of the void, then the article likely was made according to the methods disclosed herein.

In some aspects, an article comprises first and second primary surfaces, and at least one of the first and second primary surfaces comprises a textured region, a void having an edge, or both a textured region and a void having an edge. In some aspects, the textured region is an anti-glare, anti-reflection, anti-fingerprint, anti-slip, or any combination thereof feature of the surface(s). In some aspects, the textured region is present on a portion of a primary surface. For example, in some aspects, the textured region is present on X % of the surface area of the surface, in which X is at least 5, at least 10, at least 15, at least 20, at least 25, at least 30, at least 35, at least 40, at least 45, at least 50, at least 55, at least 60, at least 65, at least 70, at least 75, at least 80, at least 85, at least 90, at least 95, at least 99, 100 or less, 99 or less, 95 or less, 90 or less, 85 or less, 80 or less, 75 or less, 70 or less, 65 or less, 60 or less, 55 or less, 50 or less, 45 or less, 40 or less, 35 or less, 30 or less, 25 or less, 20 or less, 15 or less, 10 or less, or any range formed therefrom. For example, in some aspects, X (%) is 5-100, 5-99, 5-95, 5-90, 5-80, 5-70, 5-60, 5-50, 5-40, 5-30, 5-25, 5-15, 5-10, 10-100, 10-99, 10-95, 10-90, 10-80, 10-70, 10-60, 10-55, 10-45, 10-30, 10-15, 15-100, 15-99, 15-95, 15-90, 15-85, 15-75, 15-70, 15-55, 15-45, 15-40, 15-30, 15-25, 15-20, 20-100, 20-99, 20-95, 20-85, 20-75, 20-65, 20-50, 20-35, 20-30, 30-100, 30-99, 30-95, 30-80, 30-70, 30-60, 30-50, 30-40, 40-100, 40-99, 40-90, 40-80, 40-70, 40-60, 40-50, 50-100, 50-99, 50-95, 50-90, 50-80, 50-70, 50-60, 60-100, 60-90, 60-80, 60-70, 70-100, 70-90, 70-80, 80-100, 80-90, 90-100, or 95-100. In particular, in some aspects, the textured region is present on 20-80%, 50-90%, or at least 50% of the surface area of a primary surface.

In some aspects, an article has a depth of compression (DOC, e.g., DOC1, DOC2, or both) of any suitable depth. In some aspects, the DOC (microns) is at least 80, at least 90, at least 100, at least 110, at least 120, at least 130, at least 140, 150 or less, 140 or less, 130 or less, 120 or less, 110 or less, 100 or less, 90 or less, or any range formed therefrom. For example, in some aspects, the DOC (microns) is 80-150, 80-140, 80-130, 80-120, 80-110, 80-100, 80-90, 90-150, 90-140, 90-130, 90-120, 90-110, 90-100, 100-150, 100-140, 100-130, 100-120, 100-110, 110-150, 110-140, 110-130, 110-120, 120-150, 120-140, 120-130, 130-150, 130-140, or 140-150. In particular, in some aspects, the DOC (microns) is 80-150, 90-140, or 100-130.

In some aspects, an article has a maximum compressive stress (maximum CS) (MPa) of at least 100, at least 150, at least 200, at least 250, at least 300, at least 350, at least 400, at least 450, at least 500, at least 550, at least 600, at least 650, at least 700, at least 750, at least 800, at least 850, at least 900, at least 950, 1000 or less, 950 or less, 900 or less, 850 or less, 800 or less, 750 or less, 700 or less, 650 or less, 600 or less, 550 or less, 500 or less, 450 or less, 400 or less, 350 or less, 300 or less, 250 or less, 200 or less, 150 or less, or any range formed therefrom. For example, in some aspects, the maximum CS (MPa) is 100-1000, 100-900, 100-800, 100-700, 100-600, 100-500, 100-400, 100-300, 100-200, 150-700, 150-600, 150-500, 150-400, 150-300, 150-200, 200-1000, 200-900, 200-800, 200-700, 200-600, 200-500, 200-400, 200-300, 250-700, 250-600, 250-500, 250-400, 250-300, 300-1000, 300-900, 300-800, 300-700, 300-600, 300-500, 300-400, 350-700, 350-600, 350-500, 350-400, 400-1000, 400-900, 400-800, 400-700, 400-600, 400-500, 450-700, 450-600, 450-500, 500-1000, 500-900, 500-800, 500-700, 500-600, 550-700, 550-600, 600-1000, 600-900, 600-800, 600-700, 650-700, 700-1000, 700-900, or 800-1000. In particular, in some aspects, the maximum CS (MPa) is 100-1000, at least 700, 250-550, 500-1000, or 700-1000.

In some aspects, an article has a maximum central tension (maximum CT) (MPa) of at least 40, at least 60, at least 80, at least 100, at least 120, at least 140, at least 160, at least 180, at least 200, at 220 or less, 200 or less, 180 or less, 160 or less, 140 or less, 120 or less, 100 or less, 80 or less, 60 or less, or any range formed therefrom. For example, in some aspects, the maximum CT (MPa) is 40-220, 40-200, 40-180, 40-160, 40-140, 40-120, 40-100, 40-80, 40-60, 60-220, 60-200, 60-180, 60-160, 60-140, 60-120, 60-100, 60-80, 80-220, 80-200, 80-180, 80-160, 80-140, 80-120, 80-100, 100-220, 100-180, 100-160, 100-140, 100-120, 120-220, 120-200, 120-180, 120-160, 120-140, 140-220, 140-200, 140-180, 140-160, 160-220, 160-200, 160-180, 180-220, 180-200, or 200-220. In particular, in some aspects, the maximum CT (MPa) is 40-220, 100-220, or 140-180.

In some aspects, an article comprises at least one region that satisfies Equation 1, in which Can is an average normalized intensity of calcium in a first 50 nm region, Cant is an average normalized intensity of calcium in a second 50 nm region immediately adjacent to the first 50 nm region, both the first and second 50 nm regions are within a depth of 25 nm to 5000 nm from the first primary surface, and both Caₙ and Ca_{n±1} are measured by SIMS analysis:

$$\vert \frac{( {Ca}_{n} - {Ca}_{n \pm 1} )}{{Ca}_{n}} \vert \times 100 > 15 \% . \qquad ( Equation 1 )$$

The significance of Equation 1 is described elsewhere herein. In some aspects, the value of the right side of Equation 1 is at least 15%, at least 16%, at least 18%, at least 20%, at least 22%, at least 24%, at least 26%, at least 28%, at least 30%, at least 32%, at least 34%, at least 36%, at least 38%, at least 40%, at least 42%, at least 44%, at least 46%, at least 48%, at least 50%, 50% or less, 48% or less, 46% or less, 44% or less, 42% or less, 40% or less, 38% or less, 36% or less, 34% or less, 32% or less, 30% or less, 28% or less, 26% or less, 24% or less, 22% or less, 20% or less, 18% or less, 16% or less, or any range formed therefrom. For example, in some aspects, the value (%) is 15-50, 15-48, 15-46, 15-44, 15-42, 15-40, 15-38, 15-36, 15-34, 15-32, 15-30, 15-28, 15-26, 15-24, 15-22, 15-20, 15-18, 15-16, 16-50, 16-48, 16-46, 16-44, 16-42, 16-40, 16-38, 16-36, 16-34, 16-32, 16-30, 16-28, 16-26, 16-24, 16-22, 16-20, 16-18, 18-50, 18-48, 18-46, 18-44, 18-42, 18-40, 18-38, 18-36, 18-34, 18-32, 18-30, 18-28, 18-26, 18-24, 18-22, 18-20, 20-50, 20-48, 20-46, 20-44, 20-42, 20-40, 20-38, 20-36, 20-34, 20-32, 20-30, 20-28, 20-26, 20-24, 20-22, 22-50, 22-48, 22-46, 22-44, 22-42, 22-40, 22-38, 22-36, 22-34, 22-32, 22-30, 22-28, 22-26, 22-24, 24-50, 24-48, 24-46, 24-44, 24-42, 24-40, 24-38, 24-36, 24-34, 24-32, 24-30, 24-28, 24-26, 26-50, 26-48, 26-46, 26-44, 26-42, 26-40, 26-38, 26-36, 26-34, 26-32, 26-30, 26-28, 28-50, 28-48, 28-46, 28-44, 28-42, 28-40, 28-38, 28-36, 28-34, 28-32, 28-30, 30-50, 30-48, 30-46, 30-44, 30-42, 30-40, 30-38, 30-36, 30-34, 30-32, 32-50, 32-48, 32-46, 32-44, 32-42, 32-40, 32-38, 32-36, 32-34, 34-50, 34-48, 34-46, 34-44, 34-42, 34-40, 34-38, 34-36, 36-50, 36-48, 36-46, 36-44, 36-42, 36-40, 36-38, 38-50, 38-48, 38-46, 38-44, 38-42, 38-40, 40-50, 40-48, 40-46, 40-44, 40-42, 42-50, 42-48, 42-46, 42-44, 44-50, 44-48, 44-46, 46-50, 46-48, or 48-50. In particular, in some aspects, the value is at least 15, at least 18, 15-50, 24-44, 20-50, or 32-46.

In some aspects, the article is substantially free of line defects, is substantially free of a low index layer, or both. In some aspects, the article has, when measured at a thickness of 0.55 mm, at least a portion comprising an opacity of 5 to 99%; an Sq surface roughness of 0.0005-0.005 μm; a haze of 10-60%; a CT*TA of 3500-7000 MPa²*μm; or any combination thereof. In some aspects, the “portion” is X % of the surface area of the surface, in which X is at least 5, at least 10, at least 15, at least 20, at least 25, at least 30, at least 35, at least 40, at least 45, at least 50, at least 55, at least 60, at least 65, at least 70, at least 75, at least 80, at least 85, at least 90, at least 95, at least 99, 100 or less, 99 or less, 95 or less, 90 or less, 85 or less, 80 or less, 75 or less, 70 or less, 65 or less, 60 or less, 55 or less, 50 or less, 45 or less, 40 or less, 35 or less, 30 or less, 25 or less, 20 or less, 15 or less, 10 or less, or any range formed therefrom. For example, in some aspects, X (%) is 5-100, 5-99, 5-95, 5-90, 5-80, 5-70, 5-60, 5-50, 5-40, 5-30, 5-25, 5-15, 5-10, 10-100, 10-99, 10-95, 10-90, 10-80, 10-70, 10-60, 10-55, 10-45, 10-30, 10-15, 15-100, 15-99, 15-95, 15-90, 15-85, 15-75, 15-70, 15-55, 15-45, 15-40, 15-30, 15-25, 15-20, 20-100, 20-99, 20-95, 20-85, 20-75, 20-65, 20-50, 20-35, 20-30, 30-100, 30-99, 30-95, 30-80, 30-70, 30-60, 30-50, 30-40, 40-100, 40-99, 40-90, 40-80, 40-70, 40-60, 40-50, 50-100, 50-99, 50-95, 50-90, 50-80, 50-70, 50-60, 60-100, 60-90, 60-80, 60-70, 70-100, 70-90, 70-80, 80-100, 80-90, 90-100, or 95-100. In particular, in some aspects, the “portion” is 20-80%, 50-90%, or at least 50% of the surface area of a primary surface.

In particular, in some aspects, an article has at least a portion comprising, when measured at a thickness of 0.55 mm, an opacity (%) of at least 5, at least 10, at least 20, at least 30, at least 40, at least 50, at least 60, at least 70, at least 80, at least 90, at least 99, 100 or less, 99 or less, 90 or less, 80 or less, 70 or less, 60 or less, 50 or less, 40 or less, 30 or less, 20 or less, 10 or less, or any range formed therefrom. For example, in some aspects, the opacity (%) is 5-100, 5-99, 5-90, 5-80, 5-70, 5-60, 5-50, 5-40, 5-30, 5-20, 5-10, 10-100, 10-99, 10-90, 10-80, 10-70, 10-60, 10-50, 10-40, 10-30, 10-20, 20-100, 20-99, 20-90, 20-80, 20-70, 20-60, 20-50, 20-40, 20-30, 30-100, 30-99, 30-90, 30-80, 30-70, 30-60, 30-50, 30-40, 40-100, 40-99, 40-90, 40-80, 40-70, 40-60, 40-50, 50-100, 50-99, 50-90, 50-80, 50-70, 50-60, 60-100, 60-99, 60-90, 60-80, 60-70, 70-100, 70-99, 70-90, 70-80, 80-100, 80-99, 80-90, 90-100, 90-99, or 99-100. In particular, in some aspects, the opacity (%) is 5-100, 5-99, 30-90, or 60-99.

In particular, in some aspects, an article has at least a portion comprising an Sq surface roughness (microns) of at least 0.0005, at least 0.0006, at least 0.0008, at least 0.001, at least 0.002, at least 0.003, at least 0.004, 0.005 or less, 0.004 or less, 0.003 or less, 0.002 or less, 0.001 or less, 0.0008 or less, 0.0006 or less, or any range formed therefrom. For example, in some aspects, the Sq surface roughness (microns) is 0.0005-0.005, 0.0005-0.004, 0.0005-0.003, 0.0005-0.002, 0.0005-0.001, 0.0005-0.0008, 0.0005-0.0006, 0.0006-0.005, 0.0006-0.004, 0.0006-0.003, 0.0006-0.002, 0.0006-0.001, 0.0006-0.0008, 0.0008-0.005, 0.0008-0.004, 0.0008-0.003, 0.0008-0.002, 0.0008-0.001, 0.001-0.005, 0.001-0.004, 0.001-0.003, 0.001-0.002, 0.002-0.005, 0.002-0.004, 0.002-0.003, 0.003-0.005, 0.003-0.004, or 0.004-0.005. In particular, in some aspects, the Sq surface roughness (microns) is 0.0005-0.005, 0.0005-0.001, 0.005-0.002, or 0.0008-0.003.

In particular, in some aspects, an article has at least a portion comprising, when measured at a thickness of 0.55 mm, a haze (%) of at least 10, at least 15, at least 20, at least 25, at least 30, at least 35, at least 40, at least 45, at least 50, at least 55, 60 or less, 55 or less, 50 or less, 45 or less, 40 or less, 35 or less, 30 or less, 25 or less, 20 or less, 15 or less, or any range formed therefrom. For example, in some aspects, the haze (%) is 10-60, 10-55, 10-50, 10-45, 10-40, 10-35, 10-30, 10-25, 10-20, 10-15, 15-60, 15-55, 15-50, 15-45, 15-40, 15-35, 15-30, 15-25, 15-20, 20-60, 20-55, 20-50, 20-45, 20-40, 20-35, 20-30, 20-25, 25-60, 25-55, 25-50, 25-45, 25-40, 25-35, 25-30, 30-60, 30-55, 30-50, 30-45, 30-40, 30-35, 35-60, 35-55, 35-50, 35-45, 35-40, 40-60, 40-55, 40-50, 40-45, 45-60, 45-55, 45-50, 50-60, 50-55, or 55-60. In particular, in some aspects the haze (%) is 10-60, 30 or less, 10-30, or 10-35.

In particular, in some aspects, an article has at least a portion comprising a CT*TA (MPa²*μm) of at least 3500, at least 4000, at least 4500, at least 5000, at least 5500, at least 6000, at least 6500, 7000 or less, 6500 or less, 6000 or less, 5500 or less, 5000 or less, 4500 or less, 4000 or less, or any range formed therefrom. For example, in some aspects, the CT*TA (MPa²*μm) is 3500-7000, 3500-6500, 3500-6000, 3500-5500, 3500-5000, 3500-4500, 3500-4000, 4000-7000, 4000-6500, 4000-6000, 4000-5500, 4000-5000, 4000-4500, 4500-7000, 4500-6500, 4500-6000, 4500-5500, 4500-5000, 5000-7000, 5000-6500, 5000-6000, 5000-5500, 5500-7000, 5500-6500, 5500-6000, 6000-7000, 6000-6500, or 6500-7000. In particular, in some aspects, the CT*TA (MPa²*μm) is 3500-7000, 4000-6000, at least 4000, or 4500-5500.

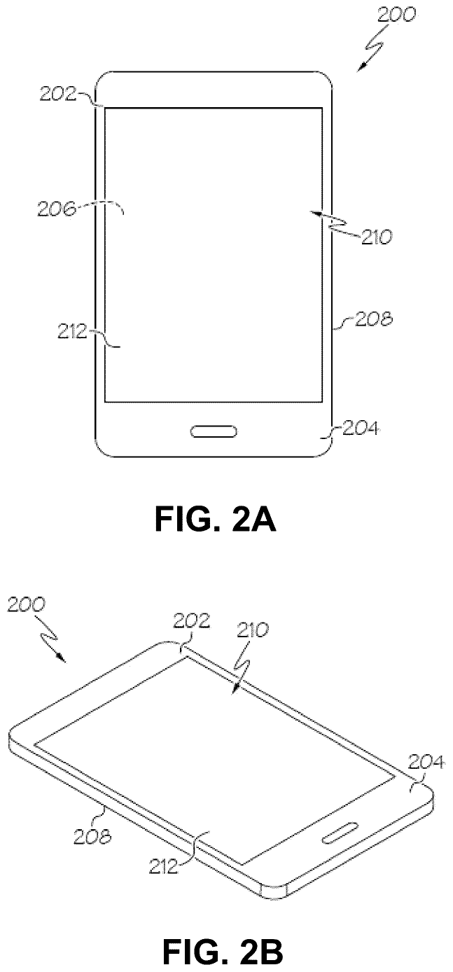

In some aspects, the articles disclosed herein may be incorporated into another device such as a device with a display (or display devices) (e.g., consumer electronics, including mobile phones, tablets, computers, navigation systems, and the like), architectural articles, transportation articles (e.g., automobiles, trains, aircraft, sea craft, etc.), appliance articles, or any device that requires some transparency, scratch-resistance, abrasion resistance or a combination thereof. An exemplary device incorporating any of the articles disclosed herein is shown in FIG. 2A and FIG. 2B. Specifically, FIGS. 2A and 2B show a consumer electronic device 200 including a housing 202 having front 204, back 206, and side surfaces 208; electrical components (not shown) that are at least partially inside or entirely within the housing and including at least a controller, a memory, and a display 210 at or adjacent to the front surface of the housing; and a cover 212 at or over the front surface of the housing such that it is over the display. In some aspects, at least a portion of at least one of the cover 212 and the housing 202 may include any of the articles described herein.

Various aspects are contemplated herein, several of which are set forth in the paragraphs below. It is explicitly contemplated that any aspect or portion thereof can be combined to form a combination. The phrase “any other aspect herein” means any numbered aspect herein, or any aspect or aspects disclosed elsewhere herein.

Aspect 1. A method for ion-exchanging glass-ceramic substrates, the method comprising:
a first contacting step comprising contacting a first glass-ceramic substrate with a molten salt bath comprising at least one of NaNO₃ and KNO₃, whereby (1) lithium ions diffuse from the first glass-ceramic substrate into the molten salt bath to provide a first dissolved lithium ion concentration, and (2) at least one of sodium and potassium ions diffuse from the molten salt bath into the first glass-ceramic substrate, thereby forming a first glass-ceramic article;
a pH adjusting step comprising adding a pH modifier to the molten salt bath that adjusts a pH of the molten salt bath;
a lithium ion scavenging step comprising contacting a lithium ion scavenger with the molten salt bath that adjusts the first dissolved lithium ion concentration;
wherein the pH adjusting and lithium ion scavenging steps (1) take place simultaneously or sequentially in any order, and (2) in combination provide a regenerated molten salt bath having a pH of 6-8 and a second dissolved lithium ion concentration of 115-250 ppm based on 100 wt. % of a sum total of NaNO₃ and KNO₃, if present; and
a second contacting step comprising contacting a second glass-ceramic substrate with the regenerated molten salt bath, whereby (1) lithium ions diffuse from the second glass-ceramic substrate into the regenerated molten salt bath, and (2) at least one of sodium and potassium ions diffuse from the regenerated molten salt bath into the second glass-ceramic substrate, thereby forming a second glass-ceramic article.

Aspect 2. The method of aspect 1, any preceding aspect, or any other aspect herein, wherein the lithium ion scavenger comprises a metasilicate, a sodium-containing glass-based material having a different composition than the first glass-ceramic substrate, or any combination thereof.

Aspect 3. The method of aspect 2, any preceding aspect, or any other aspect herein, wherein the lithium ion scavenger comprises the metasilicate, and the metasilicate is sodium metasilicate, potassium metasilicate, or a combination thereof.

Aspect 4. The method of any one of aspects 1-3, any preceding aspect, or any other aspect herein, wherein the lithium ion scavenger is present in an amount of 0.2-2 parts by weight (pbw) relative to 100 pbw of a sum total of NaNO₃ and KNO₃, if present.

Aspect 5. The method of any one of aspects 1-4, any preceding aspect, or any other aspect herein, wherein, during the lithium ion scavenging step, the lithium ion scavenger is at least partially contained within a perforated vessel.

Aspect 6. The method of any one of aspects 1-5, any preceding aspect, or any other aspect herein, wherein the lithium ion scavenging step is performed at a temperature of 450-600° C. for a time period of 1-8 hours.

Aspect 7. The method of any one of aspects 1-6, any preceding aspect, or any other aspect herein, wherein the pH modifier is silicic acid, metasilicic acid, disilicate, ortho silicic acid, pyrosilicate, B₂O₃, Al₂O₃, or any combination thereof.

Aspect 8. The method of any one of aspects 1-7, any preceding aspect, or any other aspect herein, wherein the molten salt bath comprises 0-0.1 wt. % trisodium phosphate, based on 100 wt. % of a sum total of NaNO₃ and KNO₃, if present.

Aspect 9. The method of any one of aspects 1-8, any preceding aspect, or any other aspect herein, wherein the molten salt bath comprises KNO₃ and NaNO₃.

Aspect 10. The method of any one of claims 1-9, wherein the first glass-ceramic substrate comprises aluminosilicate.

Aspect 11. The method of any one of aspects 1-10, any preceding aspect, or any other aspect herein, wherein the first contacting step comprises contacting the first glass-ceramic substrate with the molten salt bath at a temperature of 450-600° C. for a time period of 1-12 hours.

Aspect 12. The method of any one of aspects 1-11, any preceding aspect, or any other aspect herein, wherein the first contacting step comprises immersing the first glass-ceramic substrate in the molten salt bath, and the method further comprises, after the first contacting step but before the lithium ion scavenging step, removing the first glass-ceramic article from the molten salt bath.

Aspect 13. The method of any one of aspects 1-12, any preceding aspect, or any other aspect herein, wherein the second glass-ceramic article is not subjected to a mechanical polishing step to mechanically abrade at least a portion of a surface thereof sufficient to remove at least a portion of a line defect and/or a low index layer, if present.

Aspect 14. A method for ion-exchanging glass-ceramic substrates, the method comprising:
a first contacting step comprising contacting a first glass-ceramic substrate with a molten salt bath comprising a lithium ion buffer and at least one of NaNO₃ and KNO₃, whereby (1) lithium ions diffuse from the first glass-ceramic substrate into the molten salt bath to provide a first dissolved lithium ion concentration, and (2) at least one of sodium and potassium ions diffuse from the molten salt bath into the first glass-ceramic substrate, thereby forming a first glass-ceramic article;
a pH adjusting step comprising adding a pH modifier to the molten salt bath that adjusts a pH of the molten salt bath;
a lithium ion scavenging step comprising contacting a lithium ion scavenger with the molten salt bath that, in conjunction with the lithium ion buffer, adjusts the first dissolved lithium ion concentration, optionally wherein the lithium ion scavenger comprises a sodium-containing glass-based material having a different composition than the first glass-ceramic substrate;
wherein the pH adjusting and lithium ion scavenging steps (1) take place simultaneously or sequentially in any order, and (2) in combination provide a regenerated molten salt bath having a pH of 9-11 and a second dissolved lithium ion concentration of 115-250 ppm based on 100 wt. % of a sum total of NaNO₃ and KNO₃, if present; and
a second contacting step comprising contacting a second glass-ceramic substrate with the regenerated molten salt bath, whereby (1) lithium ions diffuse from the second glass-ceramic substrate into the regenerated molten salt bath, and (2) at least one of sodium and potassium ions diffuse from the regenerated molten salt bath into the second glass-ceramic substrate, thereby forming a second glass-ceramic article.

Aspect 15. The method of aspect 14, any preceding aspect, or any other aspect herein, wherein the lithium ion scavenger comprises a metasilicate, a sodium-containing glass-based material having a different composition than the first glass-ceramic substrate, or any combination thereof.

Aspect 16. The method of aspect 15, any preceding aspect, or any other aspect herein, wherein the lithium ion scavenger comprises the metasilicate, and the metasilicate is sodium metasilicate, potassium metasilicate, or a combination thereof.

Aspect 17. The method of any one of aspects 14-16, any preceding aspect, or any other aspect herein, wherein the lithium ion scavenger is present in an amount of 0.2-2 parts by weight (pbw) relative to 100 pbw of a sum total of NaNO₃ and KNO₃, if present.

Aspect 18. The method of any one of aspects 14-17, any preceding aspect, or any other aspect herein, wherein, during the lithium ion scavenging step, the lithium ion scavenger is at least partially contained within a perforated vessel.

Aspect 19. The method of any one of aspects 14-18, any preceding aspect, or any other aspect herein, wherein the lithium ion scavenging step is performed at a temperature of 450-600° C. for a time period of 1-8 hours.

Aspect 20. The method of any one of aspects 14-19, any preceding aspect, or any other aspect herein, wherein the pH modifier is silicic acid, metasilicic acid, disilicate, ortho silicic acid, pyrosilicate, B₂O₃, Al₂O₃, or any combination thereof.

Aspect 21. The method of any one of aspects 14-20, any preceding aspect, or any other aspect herein, wherein the lithium ion buffer comprises trisodium phosphate.

Aspect 22. The method of any one of aspects 14-21, any preceding aspect, or any other aspect herein, wherein the lithium ion buffer is present in the first and second contacting steps in an amount of 0.1-0.4 pbw relative to 100 pbw of a sum total of NaNO₃ and KNO₃, if present.

Aspect 23. The method of any one of aspects 14-22, any preceding aspect, or any other aspect herein, wherein additional lithium ion buffer is not added to the regenerated molten salt bath.

Aspect 24. The method of any one of aspects 14-23, any preceding aspect, or any other aspect herein, wherein the molten salt bath comprises KNO₃ and NaNO₃.

Aspect 25. The method of any one of aspects 14-24, any preceding aspect, or any other aspect herein, wherein the first glass-ceramic substrate comprises aluminosilicate.

Aspect 26. The method of any one of aspects 14-25, any preceding aspect, or any other aspect herein, wherein the first contacting step comprises contacting the first glass-ceramic substrate with the molten salt bath at a temperature of 450-550° C. for a time period of 1-12 hours.

Aspect 27. The method of any one of aspects 14-26, any preceding aspect, or any other aspect herein, wherein the first contacting step comprises immersing the first glass-ceramic substrate in the molten salt bath, and the method further comprises, after the first contacting step but before the lithium ion scavenging step, removing the first glass-ceramic article from the molten salt bath.

Aspect 28. The method of any one of aspects 14-27, any preceding aspect, or any other aspect herein, wherein the second glass-ceramic article is not subjected to a mechanical polishing step sufficient to mechanically abrade at least a portion of a surface thereof sufficient to remove at least a portion of a line defect and/or a low index layer, if present.

Aspect 29. The method of any preceding aspect, or any other aspect herein, wherein the second glass-ceramic article:
is substantially free of line defects; and
is substantially free of a low index layer.

Aspect 30. The method of any preceding aspect, or any other aspect herein, wherein the second glass-ceramic article has, when measured at a thickness of 0.55 mm, at least a portion comprising:
an opacity of 5 to 99%;
an Sq surface roughness of 0.0005-0.005 μm;
a haze of 10-60%;
a CT*TA of 3500-7000 MPa²*μm; or
any combination thereof.

Aspect 31. The method of any preceding aspect, or any other aspect herein, wherein the second glass-ceramic article comprises:
a petalite crystalline phase; and
a lithium silicate crystalline phase.

Aspect 32. The method of aspect 31, any preceding aspect, or any other aspect herein, wherein a sum total of the petalite crystalline phase and the lithium silicate crystalline phase is a higher weight percentage than a sum total of all other crystalline phases, if any, present in the second glass-ceramic article.

Aspect 33. The method of aspect 31 or 32, any preceding aspect, or any other aspect herein, wherein the second glass-ceramic article has an average transmittance greater than 85% over the wavelength range from 400 nm to 1000 nm for a glass-ceramic article thickness of 1 mm.

Aspect 34. The method of any one of aspects 31-33, any preceding aspect, or any other aspect herein, wherein the second glass-ceramic article comprises grains and the grains have a longest dimension of less than 100 nm.

Aspect 35. The method of any one of aspects 31-34, any preceding aspect, or any other aspect herein, wherein the second glass-ceramic article has a composition at its center comprising:
55-80 wt. % SiO₂;
2-20 wt. % Al₂O₃;
5-20 wt. % Li₂O;
0-5 wt. % Na₂O;
0-5 wt. % K₂O;
>0-5 wt. % CaO;
>0-6 wt. % P₂O₅; and
0.2-15 wt. % ZrO₂;
wherein ZrO₂ wt. %+P₂O₅ wt. %>1 wt. %.

Aspect 36. The method of aspect 35, any preceding aspect, or any other aspect herein, comprising at least one of:
2-10 wt. % Al₂O₃;
10-20 wt. % Li₂O;
>0-3 wt. % Na₂O;
>0-3 wt. % K₂O;
>0-3 wt. % CaO;
>0-4 wt. % P₂O₅;
3-15 wt. % ZrO₂; and
ZrO₂ wt. %+P₂O₅ wt. %>3 wt. %.

Aspect 37. The method of aspect 35 or 36, any preceding aspect, or any other aspect herein, further comprising HfO₂ in an amount of >0 wt. % to ≤3 wt. %.

Aspect 38. The second glass-ceramic article produced by the method of any preceding aspect, or any other aspect herein.

Aspect 39. A glass-ceramic article, comprising:
first and second primary surfaces, the first primary surface comprising a textured region, a void having an edge, or both the textured region and the void having the edge;
a first compressive stress layer extending from the first primary surface to a first depth of compression (DOC1) and a second compressive stress layer extending from the second primary surface to a second depth of compression (DOC2);
a central tension region extending from DOC1 to DOC2; and
at least one region that satisfies Equation 1:

$$\vert \frac{( {Ca}_{n} - {Ca}_{n \pm 1} )}{{Ca}_{n}} \vert \times 100 > 15 \% ; \qquad ( Equation 1 )$$

wherein Caₙ is an average normalized intensity of calcium in a first 50 nm region, Ca_{n±1} is an average normalized intensity of calcium in a second 50 nm region immediately adjacent to the first 50 nm region, both the first and second 50 nm regions are within a depth of 25 nm to 5000 nm from the first primary surface, and both Caₙ and Ca_{n±1} are measured by SIMS analysis;
wherein at least one of the textured region and the edge, if present, is substantially free of line defects; and
wherein at least one of the textured region and the edge, if present, is substantially free of a low index layer.

Aspect 40. The glass-ceramic article of aspect 39, any preceding aspect, or any other aspect herein, wherein the textured region is present on at least 50% of a surface area of the first primary surface.

Aspect 41. The glass-ceramic article of aspect 39 or 40, any preceding aspect, or any other aspect herein, comprising:
a petalite crystalline phase; and
a lithium silicate crystalline phase.

Aspect 42. The glass-ceramic article of any one of aspects 39-41, any preceding aspect, or any other aspect herein, wherein a sum total of the petalite crystalline phase and the lithium silicate crystalline phase is a higher weight percentage than a sum total of all other crystalline phases, if any, present in the glass-ceramic article.

Aspect 43. The glass-ceramic article of any one of aspects 39-42, any preceding aspect, or any other aspect herein, wherein the glass-ceramic article has an average transmittance greater than 85% over the wavelength range from 400 nm to 1000 nm for a glass-ceramic article thickness of 1 mm.

Aspect 44. The glass-ceramic article of any one of aspects 39-43, any preceding aspect, or any other aspect herein, wherein the glass-ceramic article comprises grains and the grains have a longest dimension of less than 100 nm.

Aspect 45. The glass-ceramic article of any one of aspects 39-44, any preceding aspect, or any other aspect herein, wherein the glass-ceramic article has a composition at its center comprising:
55-80 wt. % SiO₂;
2-20 wt. % Al₂O₃;
5-20 wt. % Li₂O;
0-5 wt. % Na₂O;
0-5 wt. % K₂O;
>0-5 wt. % CaO;
>0-6 wt. % P₂O₅; and
0.2-15 wt. % ZrO₂;
wherein ZrO₂ wt. %+P₂O₅ wt. %>1 wt. %.

Aspect 46. The glass-ceramic article of aspect 45, any preceding aspect, or any other aspect herein, comprising at least one of:
2-10 wt. % Al₂O₃;
10-20 wt. % Li₂O;
>0-3 wt. % Na₂O;
>0-3 wt. % K₂O;
>0-3 wt. % CaO;
>0-4 wt. % P₂O₅;
0.2-15 wt. % ZrO₂; and
ZrO₂ wt. %+P₂O₅ wt. %>3 wt. %.

Aspect 47. The glass-ceramic article of aspect 45 or 46, any preceding aspect, or any other aspect herein, further comprising HfO₂ in an amount of >0 wt. % to ≤3 wt. %.

Aspect 48: A combination of any two or more preceding aspects, any portion(s) thereof, or any other aspect(s) herein.

### EXAMPLES

The following examples illustrate non-limiting aspects of the disclosure and are not intended to be limiting on the scope of the disclosure or claims.

Example 1: This example demonstrates a method of regenerating a molten salt bath so as to have an approximately neutral pH and a controlled lithium ion concentration, followed by ion-exchanging a glass-ceramic substrate in the regenerated bath.

A molten salt bath was prepared containing 80 wt. % NaNO₃ and 20 wt. % KNO₃. To this bath was then added 0.12 wt. % LiNO₃ by superaddition (i.e., 121 ppm lithium ion, to imitate a used bath) and 1 wt. % silicic acid by superaddition, both of which are based on 100 wt. % of NaNO₃+KNO₃. Ion-exchangeable glass-ceramic substrates containing petalite and lithium silicate crystalline phases, a thickness of 0.55 mm, and the composition shown in Table 1, were then ion-exchanged in this bath by immersing at a temperature of 530° C. for 4.4 hours at a loading density of 0.016 m²/kg, thereby forming a set of glass-ceramic articles. The glass-ceramic articles were then removed from the bath.

TABLE 1

| | wt. % |
|---|---|
| SiO₂ | 55-80 |
| Al₂O₃ | 2-20 |
| Li₂O | 5-20 |
| Na₂O | 0-5 |
| K₂O | 0-5 |
| CaO | >0-5 |
| P₂O₅ | >0-6 |
| ZrO₂ | 0.2-15 |
| ZrO₂ + P₂O₅ | >1 |
| HfO₂ | 0-3 |

The bath was regenerated for a time period of 4 hours by adding 0.63 wt. % sodium metasilicate by superaddition (based on 100 wt. % of NaNO₃+KNO₃) as a lithium ion scavenger, and 0.1 wt. % silicic acid by superaddition (based on 100 wt. % of NaNO₃+KNO₃). The sodium metasilicate was added in a tea bag style basket to trap the lithium ions. The combination of components in the bath ensured for at least some embodiments that the pH was maintained in a target range (e.g., 6-8), and the lithium ion concentration was maintained in a target range (e.g., 115-250 ppm).

The regenerated molten salt bath was then used to perform subsequent ion-exchange runs by immersing glass-ceramic substrates at a temperature of 530° C. for 4.4 hours at a loading density of 0.016 m²/kg, removing the resulting glass-ceramic articles, and then regenerating the bath as done before after each ion-exchange run (by adding 0.1 wt. % silicic acid and 0.63 wt. % sodium metasilicate) to generally achieve the target pH (e.g., 6-8) and target lithium ion concentration (e.g., 115-250 ppm). Eight total runs were performed, including the original bath and subsequent regenerated baths.

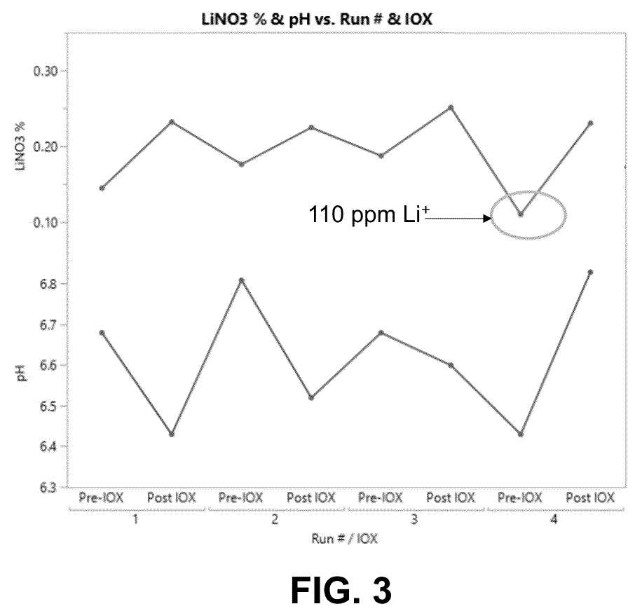

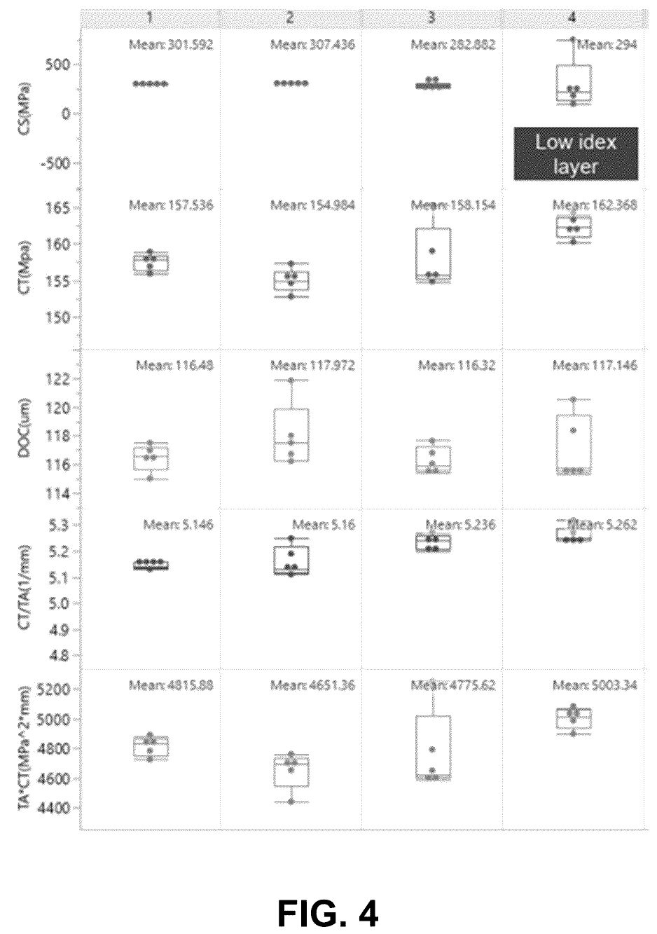

The pH, LiNO₃ concentration, CS, CT, DOC, CT/TA, and TA*CT were measured for Runs 1-4, with the results shown in FIG. 3 and FIG. 4. In particular, FIG. 3 depicts the LiNO₃ amount (based on 100 wt. % of NaNO₃+KNO₃) and pH both pre-IOX and post-IOX. The pre-IOX data is the starting point for each Run after addition of the lithium ion scavenger and pH modifier, and the post-IOX data is the ending point after the Run is complete and prior to any bath regeneration. Notably, Run 4 in FIG. 3 was conducted at a LiNO₃ concentration of 0.11 wt. % (which converts to 110 ppm lithium ion concentration), and this low amount of lithium ion undesirably caused formation of a low index layer on the surface of the glass-ceramic articles, which can lead to line defects on cooling and/or subsequent chemical repolishing. Runs 1-3 were conducted at lithium ion concentrations within the range 115-250 ppm. FIG. 4 shows the CS, CT, DOC, CT/TA, and TA*CT that were measured for the glass-ceramic articles produced in Runs 1-4. As can be seen from FIG. 4, CT*TA is maintained between 4000-5500 MPa²*mm. Runs 5-8 are discussed or further utilized in other examples.

Example 2: This example demonstrates the surface roughness and haze of the glass-ceramic articles produced in Example 1 both before and after a subsequent chemical repolish, as compared to comparative articles produced by ion-exchanging glass-ceramic substrates using an ion-exchange bath regenerated using a standard trisodium phosphate (TSP) protocol (also both before and after a subsequent chemical repolish).

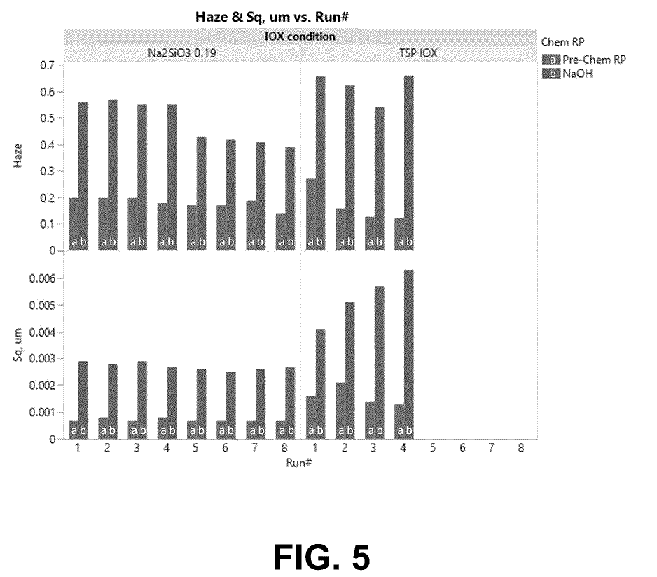

The glass-ceramic articles produced in Runs 1-8 of Example 1 were detergent washed after ion-exchange, and the haze and surface roughness were measured as follows: haze was measured using a haze meter from BYK Instruments, and surface roughness was measured using a NewView™ 9000 instrument available from Zygo Corporation using a 50× objective and 2× zoom. A chemical repolish (i.e., etching) was then performed using 70 wt. % NaOH in water at 170° C., which removed ~3 μm from each major surface of the glass-ceramic article, and the haze and surface roughness measurements were repeated. Four comparative glass-ceramic articles were prepared by ion-exchanging glass-ceramic substrates from Table 1 in Example 1 using molten salt baths regenerated using a standard TSP regeneration method. These comparative examples were performed similarly to the ion exchange and regeneration conditions of Example 1, except that the bath was preloaded with both 0.2 wt. % of LiNO₃ and 0.3 wt. % TSP by superaddition, following by regeneration with 0.11 wt. % TSP by direct superaddition (without a tea bag-style basket) for at least four hours to regenerate the bath. The results are set forth in Table 2 and FIG. 5.

TABLE 2

| Run | | Haze | Sq (μm) |
|---|---|---|---|
| 1 | Pre-repolish | 0.2 | 0.0007 |
| | Post-repolish | 0.56 | 0.0029 |
| 2 | Pre-repolish | 0.2 | 0.0008 |
| | Post-repolish | 0.57 | 0.0028 |
| 3 | Pre-repolish | 0.2 | 0.0007 |
| | Post-repolish | 0.55 | 0.0029 |
| 4 | Pre-repolish | 0.18 | 0.0008 |
| | Post-repolish | 0.55 | 0.0027 |
| 5 | Pre-repolish | 0.17 | 0.0007 |
| | Post-repolish | 0.43 | 0.0026 |
| 6 | Pre-repolish | 0.17 | 0.0007 |
| | Post-repolish | 0.42 | 0.0025 |
| 7 | Pre-repolish | 0.19 | 0.0007 |
| | Post-repolish | 0.41 | 0.0026 |
| 8 | Pre-repolish | 0.14 | 0.0007 |
| | Post-repolish | 0.39 | 0.0027 |

As show in Table 2 and FIG. 5, the surface haze and roughness desirably stay at low levels even after eight runs. Compared to the glass-ceramic articles produced using the typical TSP regeneration method, the surface roughness (both pre-repolish and post-repolish) and the post-repolish haze are lower for the glass-ceramic articles produced from ion-exchange baths regenerated according to Example 1.

Example 3: This example demonstrates the formation of line defects under low lithium ion concentration.

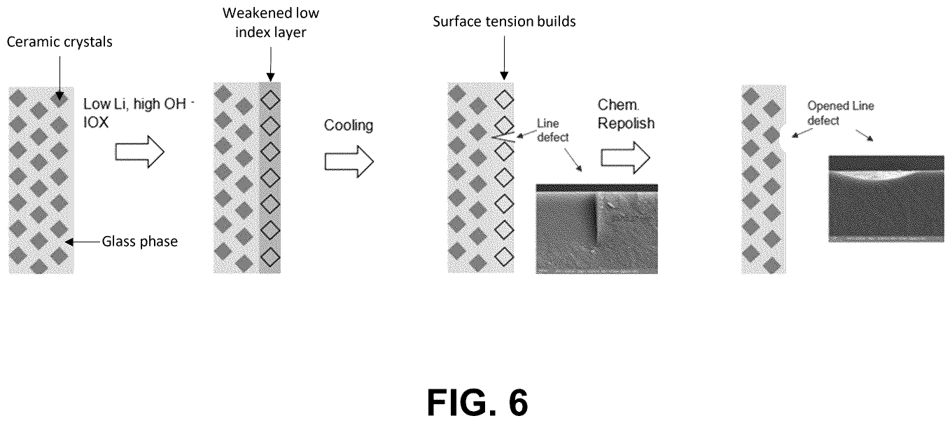

Without wishing to be bound by theory, FIG. 6 sets forth a proposed mechanism for how and why a line defect forms and is exacerbated by chemical repolishing, along with inset images of line defects. In particular, it is believed that low lithium ion concentration in conjunction with OH⁻ ions (e.g., present as a result of decomposition of NaNO₃) break down the network in the glass-ceramic, forming a weakened low index layer. The weakened low index layer generates a tensile stress upon cooling after removal of the glass-ceramic article from the IOX bath, causing a thin line defect to form. Upon chemical repolishing (e.g., HF or OH⁻) the thin line defect opens up due to the chemical etchants entering the line defect and continuing to etch, making the line defect more visible in the resulting glass-ceramic article, which is an undesirable cosmetic and potentially structural defect. As described herein, formation of line defects can be prevented by employing the methods herein. For example, it is believed that keeping the lithium ion concentration in the target range, in conjunction with keeping the pH in the target range, prevents formation of a low index layer, which thereby prevents formation of line defects on the surface of the resulting glass-ceramic article. Too low of a lithium ion concentration results in formation of a low index layer, whereas too high of a lithium ion concentration impedes the ion-exchange of sodium and/or potassium ions into the glass-ceramic and the lithium ions out of the glass-ceramic.

Examples of line defects and low index layers are shown in FIG. 7A, FIG. 7B, FIG. 8A, FIG. 8B, and FIG. 9, which employ the substrate of Example 1 ion exchanged with regenerated baths that are not in conformance with the methods disclosed herein. In particular, FIG. 7A shows an optical image under a microscope of a line defect after chemically repolishing an ion-exchanged glass-ceramic article, and FIG. 7B shows a zoomed-in image of FIG. 7A. FIG. 8A shows a scanning electron microscopy (SEM) image of a line defect after ion-exchange without chemical repolishing, and FIG. 8B shows a cross-section of a low index layer on the surface of the article of FIG. 8A. The SEM parameters for FIG. 8A are CS Gemini 500; WD=7.1 mm; EHT=5.00 kV; Mag=8.00 K X; scale bar 1 μm; Signal A=SE2; vacuum mode=high vacuum. The SEM parameters for FIG. 8B are CS Gemini 500; WD=5.2 mm; EHT=5.00 kV; Mag=50.00 K X; scale bar 200 nm; Signal A=BSD4 A; vacuum mode=high vacuum. FIG. 9 shows the SIMS depth profiles for a line defect area (termed “Edge”) and away from the line defect area (termed “Center”). In particular, there is a discernible difference in the subsurface Na and Li contents between the probed areas near the defect area and away from the defect area, and these findings suggest that the low index layer formed on the surface may be a reverse ion-exchange of lithium ions back into the glass-ceramic article during the cooling process.

Example 4: This example demonstrates differences in calcium content in glass-ceramic articles that have been ion-exchanged and then chemically repolished, as compared to glass-ceramic articles that have been ion-exchanged but not chemically repolished.

A useful parameter for helping to determine whether a glass-ceramic article (that contains calcium as a compositional component of the glass) has been chemically repolished or not is to determine the calcium content from a primary surface of the article to a depth of around 5000 nm, typically measured using secondary ion mass spectrometry (SIMS) in terms of normalized intensity. Without chemical repolishing, there is generally a difference in calcium content in the near surface compared to deeper depths as a result of the ion exchange process. This is generally because the ion-exchange process causes calcium ions in the structure/network of the glass-ceramic to migrate to an extent in the near surface region, whereas at deeper depths the calcium ions are not affected by ion exchange and therefore remain at relatively uniform concentrations. The depths that define the “near surface” and “deeper depths,” and the extent of calcium ion migration, change depending on the extent of ion exchange, which relates to time and temperature of ion exchange. Note that the surface of the glass-ceramic at 0 nm is not a good reference point because artefacts and contamination render the actual surface nonrepresentative. With chemical repolishing, any difference in calcium content between the near-surface and deeper depths of an ion exchanged glass-ceramic article is generally erased or otherwise masked by the repolishing. As a result, if at least one 50 nm region within a depth of 25 nm to 5000 nm from a primary surface of an ion-exchanged glass-ceramic article satisfies Equation 1, then it is generally correct to conclude that the glass-ceramic article has not been chemically repolished.

$$\vert \frac{( {Ca}_{n} - {Ca}_{n \pm 1} )}{{Ca}_{n}} \vert \times 100 > 15 \% \qquad ( Equation 1 )$$

In Equation 1, Caₙ is an average normalized intensity of calcium in a first 50 nm region, Ca_{n±1} is an average normalized intensity of calcium in a second 50 nm region immediately adjacent to the first 50 nm region (either shallower or deeper than the first 50 nm), both the first and second 50 nm regions are within a depth of 25 nm to 5000 nm from a primary surface of the glass-ceramic article, and both Caₙ and Ca_{n±1} are measured by SIMS analysis.

Equation 1 captures the concept that if there is at least a 15% difference between a reference 50 nm region and an immediately adjacent (shallower or deeper) 50 nm region (relative to the reference 50 nm region), then this reflects the fact that calcium content is changing over these depths and chemical repolishing (or mechanical polishing) did not take place. The opposite is also true: if such difference is less than 15%, then chemical repolishing (or even mechanical polishing) did take place.

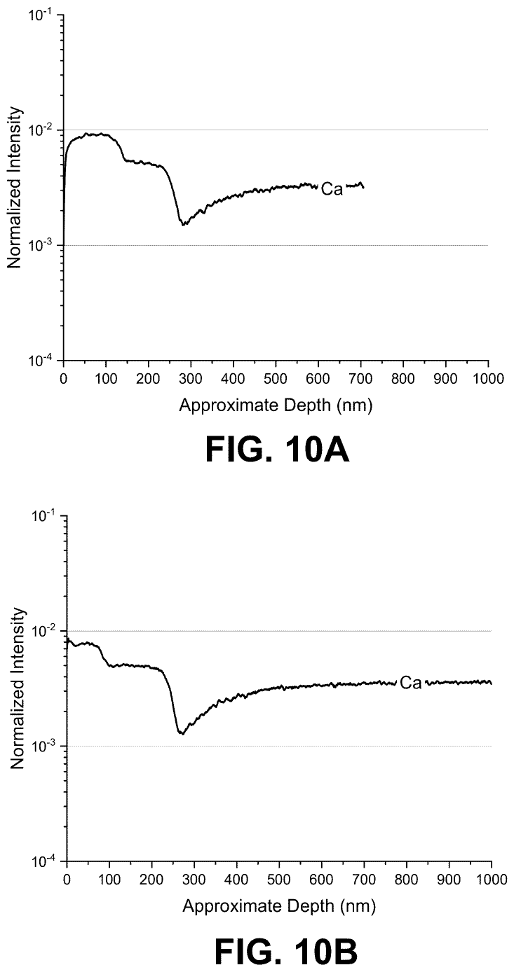

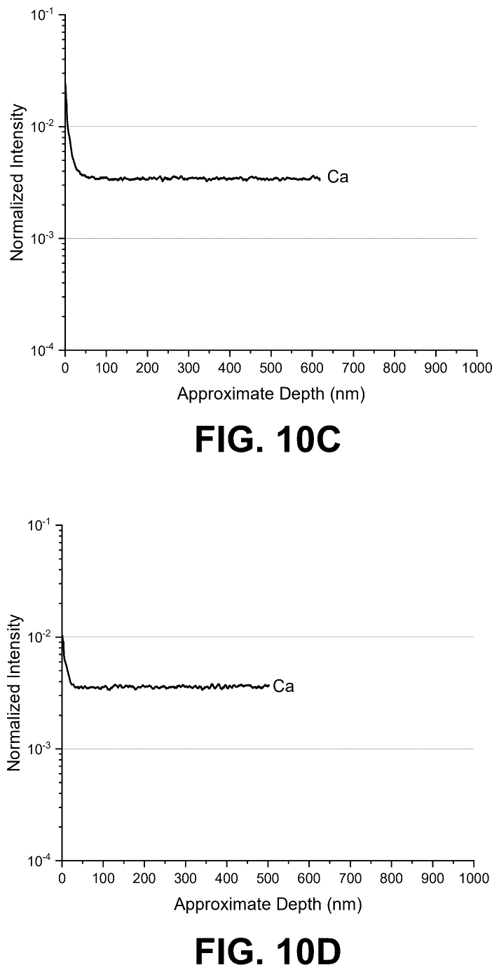

To illustrate this concept, a glass-ceramic substrate having the composition indicated in Example 1 was ion-exchanged in a regenerated IOX bath to form a glass-ceramic article using the same conditions as Example 1. After ion-exchange, the glass-ceramic article was analyzed by SIMS away from the line defect area (“Center”), and within 1 mm of the line defect area (“Edge”) (see FIG. 10A and FIG. 10B, respectively). The glass-ceramic article was then chemically repolished using 70 wt. % NaOH at 170° C. to remove ~3 micron from each primary surface, and the SIMS measurements performed again at both the Center and the Edge areas (see FIG. 10C and FIG. 10D, respectively). As can be seen by comparing FIG. 10A (prior to repolishing) and FIG. 10C (after repolishing) for the center of the article, as well as comparing FIG. 10B and FIG. 10D for the edge of the article, chemical repolishing removes the changing calcium content at the near surface depth of approximately 25-500 nm.

It is clear that the glass-ceramic article of FIG. 10A (center of surface of article) is not chemically repolished, since Equation 1 is met: the average normalized intensity of calcium in the 50 nm region of 280 nm to 330 nm is 1.76×10⁻³ (which represents Caₙ in Equation 1), and the average normalized intensity of calcium in the immediately adjacent region 50 nm region of 330 nm to 380 nm is 2.31×10⁻³ (which represents Ca_{n±1} in Equation 1), which represents a 31.3% difference according to Equation 1. In contrast, it is clear that the glass-ceramic article of FIG. 10C (center of surface article) is chemically repolished, since Equation 1 is not met: there are no two adjacent 50 nm regions that meet Equation 1. This means the glass-ceramic article of FIG. 10A is ion-exchanged but not chemically repolished, whereas the glass-ceramic article of FIG. 10B is ion-exchanged and chemically repolished.

Similarly, it is clear that the glass-ceramic article of FIG. 10B (edge of surface of article) is not chemically repolished, since Equation 1 is met: the average normalized intensity of calcium in the 50 nm region of 280 nm to 330 nm is 1.70×10⁻³ (which represents Caₙ in Equation 1), and the average normalized intensity of calcium in the immediately adjacent region 50 nm region of 330 nm to 380 nm is 2.34×10⁻³ (which represents Ca_{n±1} in Equation 1), which represents a difference of 37.6% according to Equation 1. In contrast, it is clear that the glass-ceramic article of FIG. 10D (edge of surface of article) is chemically repolished, since Equation 1 is not met: there are no two adjacent 50 nm regions that meet Equation 1. This means the glass-ceramic article of FIG. 10A is ion-exchanged but not chemically repolished, whereas the glass-ceramic article of FIG. 10B is ion-exchanged and chemically repolished.

Example 5: This example demonstrates a method of regenerating a molten salt bath that employs a lithium ion buffer, as well as a sodium-containing glass-based material as the lithium ion scavenger. The molten salt bath has an approximately weakly alkaline pH and a controlled lithium ion concentration, followed by ion-exchanging a glass-ceramic substrate in the regenerated bath.

A molten salt bath was prepared containing 80 wt. % NaNO₃ and 20 wt. % KNO₃. To this bath was then added 0.2 wt. % LiNO₃ (i.e., 202 ppm lithium ion), 1 wt. % silicic acid, and 0.3 wt. % trisodium phosphate (TSP), each of which is based on 100 wt. % of NaNO₃+KNO₃. Ion-exchangeable glass-ceramic substrates containing petalite and lithium silicate crystalline phases, a thickness of 0.55 mm, and the composition shown in Table 1 (see Example 1), were then ion-exchanged in this bath by immersing at a temperature of 530° C. for 4.4 hours at a loading density of 0.016 m²/kg, thereby forming a set of glass-ceramic articles. The glass-ceramic articles were then removed from the bath.

The bath was regenerated for a time period of 4 hours by adding 2 wt. % of a sodium-containing glass-based material (based on 100 wt. % of NaNO₃+KNO₃) as a lithium ion scavenger, and 0.1 wt. % silicic acid (based on 100 wt. % of NaNO₃+KNO₃). The scavenger was in the form of broken glass shards having a thickness of about 0.5 mm and a diameter in the mm to cm range, which was added to the bath in a tea bag style basket to trap the lithium ions. The scavenger comprised 30-85 mol. % SiO₂, 2-20 mol. % Al₂O₃, and 10-60 mol. % Na₂O. The combination of components in the bath, including TSP as the lithium ion buffer, ensured for at least some embodiments that the lithium ion concentration was maintained in a target range (e.g., 115-250 ppm), and the pH was maintained in a target range (e.g., 9-11).

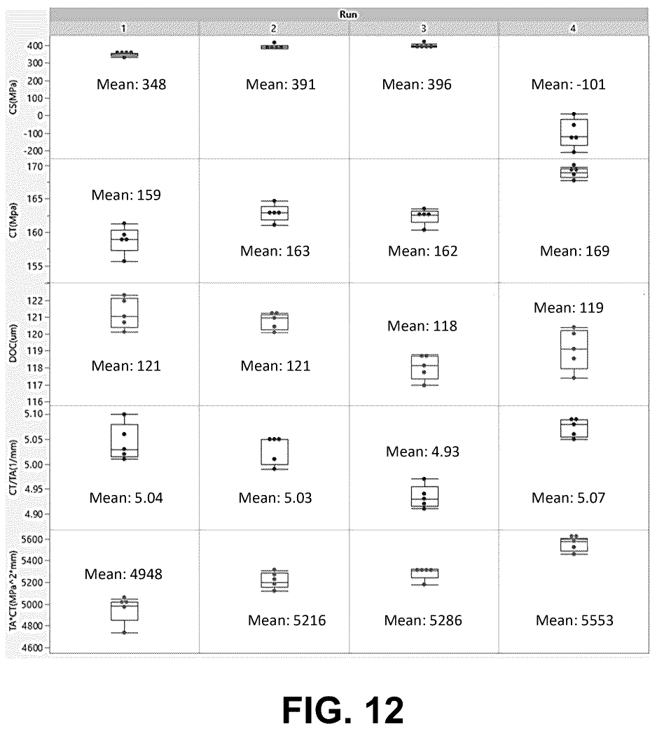

The regenerated molten salt bath was then used to perform subsequent ion-exchange runs by immersing glass-ceramic substrates at a temperature of 530° C. for 4.4 hours at a loading density of 0.016 m²/kg, removing the resulting glass-ceramic articles, and then regenerating the bath as before after each ion-exchange run (by adding 0.1 wt. % silicic acid and 2 wt. % scavenger) to generally achieve the target pH (e.g., 9-11) and target lithium ion concentration (e.g., 115-250 ppm). Additional TSP was not added to any of the regenerated baths (the original amount of TSP in the first bath was the only TSP added, and it remains in the regenerated baths as a lithium ion buffer). Four total runs were performed, including the original bath and subsequent regenerated baths. The pH, LiNO₃ concentration, CS, CT, DOC, CT/TA, and TA*CT were measured for Runs 1-4, with the results shown in FIG. 12.

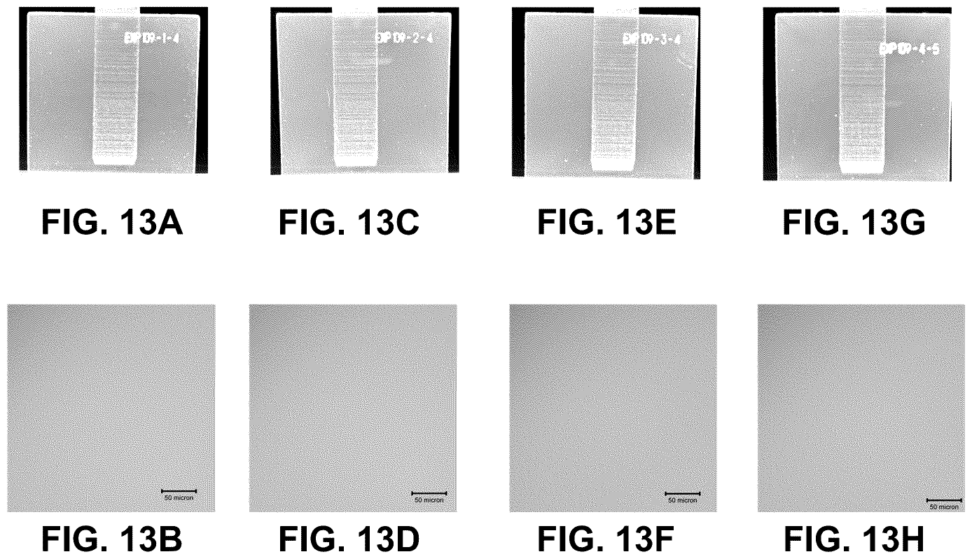

As can be seen from FIG. 12, the pH was maintained between 9-11, and the CT*TA was maintained at a high level. While the lithium ion concentration was within the target range of 115-250 ppm for each of Runs 1-3, for Run 4 the lithium ion concentration was below 115 ppm. Notably, a low index layer was formed for Run 4, which was undesirable because it can lead to line defects caused by tension crack forming in the low index layer. However, as shown in the optical microscope images shown in FIGS. 13A-13H, no line defects are observed in any of Runs 1-4. This can be explained by the presence of the lithium ion buffer, which may prevent lithium ions from reverse ion-exchanging back into the substrate. Note the scale bar in FIGS. 13B, 13D, 13F, and 13H is 50 microns.

It will be appreciated that the various disclosed aspects or embodiments may involve particular features, elements or steps that are described in connection with that particular aspect or embodiment. It will also be appreciated that a particular feature, element, or step, although described in relation to one particular aspect or embodiment, may be interchanged or combined with alternate aspects or embodiments in various non-illustrated combinations or permutations.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

While various features, elements, or steps of particular aspects or embodiments may be disclosed using the transitional phrase “comprising,” it is to be understood that alternative aspects or embodiments, including those that may be described using the transitional phrases “consisting of” or “consisting essentially of,” are implied. Thus, for example, implied alternative aspects or embodiments to a device that comprises A+B+C include aspects or embodiments where a device consists of A+B+C and aspects or embodiments where a device consists essentially of A+B+C.

References herein to the positions of elements (e.g., “top,” “bottom,” “above,” “below,” “first,” “second,” etc.) are merely used to describe the orientation of various elements in the FIGURES. It should be noted that the orientation of various elements may differ according to other exemplary embodiments, and that such variations are intended to be encompassed by the present disclosure. Moreover, these relational terms are used solely to distinguish one entity or action from another entity or action, without necessarily requiring or implying any actual such relationship or order between such entities or actions.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

As utilized herein, “optional,” “optionally,” or the like are intended to mean that the subsequently described component, event, or circumstance can or cannot occur or be present, and that the description includes instances where the component, event, or circumstance occurs/is present and instances where it does not occur/is not present. As used herein, the indefinite articles “a,” “an,” and the corresponding definite article “the” mean “at least one” or “one or more,” unless otherwise specified. It also is understood that the various features disclosed in the specification and the drawings can be used in any and all combinations.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

It will be apparent to those ordinarily skilled in the art that various modifications and variations can be made to the present disclosure without departing from the spirit and scope of the disclosure. Since modifications combinations, sub-combinations, and variations of the disclosed embodiments incorporating the spirit and substance of the disclosure may occur to persons ordinarily skilled in the art, the disclosure should be construed to include everything within the scope of the appended claims and their equivalents.

What is claimed is:

1. A method for ion-exchanging glass-ceramic substrates, the method comprising:
a first contacting step comprising contacting a first glass-ceramic substrate with a molten salt bath comprising at least one of NaNO₃ and KNO₃, whereby (1) lithium ions diffuse from the first glass-ceramic substrate into the molten salt bath to provide a first dissolved lithium ion concentration, and (2) at least one of sodium and potassium ions diffuse from the molten salt bath into the first glass-ceramic substrate, thereby forming a first glass-ceramic article;
a pH adjusting step comprising adding a pH modifier to the molten salt bath that adjusts a pH of the molten salt bath;
a lithium ion scavenging step comprising contacting a lithium ion scavenger with the molten salt bath that adjusts the first dissolved lithium ion concentration;
wherein the pH adjusting and lithium ion scavenging steps (1) take place simultaneously or sequentially in any order, and (2) in combination provide a regenerated molten salt bath having a pH of 6-8 and a second dissolved lithium ion concentration of 115-250 ppm based on 100 wt. % of a sum total of NaNO₃ and KNO₃, if present; and
a second contacting step comprising contacting a second glass-ceramic substrate with the regenerated molten salt bath, whereby (1) lithium ions diffuse from the second glass-ceramic substrate into the regenerated molten salt bath, and (2) at least one of sodium and potassium ions diffuse from the regenerated molten salt bath into the second glass-ceramic substrate, thereby forming a second glass-ceramic article.

2. The method of claim 1, wherein the lithium ion scavenger comprises a metasilicate, a sodium-containing glass-based material having a different composition than the first glass-ceramic substrate, or any combination thereof.

3. The method of claim 2, wherein the lithium ion scavenger comprises the metasilicate, and the metasilicate is sodium metasilicate, potassium metasilicate, or a combination thereof.

4. The method of claim 1, wherein the lithium ion scavenger is present in an amount of 0.2-2 parts by weight (pbw) relative to 100 pbw of a sum total of NaNO₃ and KNO₃, if present.

5. The method of claim 1, wherein, during the lithium ion scavenging step, the lithium ion scavenger is at least partially contained within a perforated vessel.

6. The method of claim 1, wherein the lithium ion scavenging step is performed at a temperature of 450-600° C. for a time period of 1-8 hours.

7. The method of claim 1, wherein the pH modifier is silicic acid, metasilicic acid, disilicate, ortho silicic acid, pyrosilicate, B₂O₃, Al₂O₃, or any combination thereof.

8. The method of claim 1, wherein the molten salt bath comprises 0-0.1 wt. % trisodium phosphate, based on 100 wt. % of a sum total of NaNO₃ and KNO₃, if present.

9. The method of claim 1, wherein the molten salt bath comprises KNO₃ and NaNO₃.

10. The method of claim 1, wherein the first glass-ceramic substrate comprises aluminosilicate.

11. The method of claim 1, wherein the first contacting step comprises contacting the first glass-ceramic substrate with the molten salt bath at a temperature of 450-600° C. for a time period of 1-12 hours.

12. The method of claim 1, wherein the first contacting step comprises immersing the first glass-ceramic substrate in the molten salt bath, and the method further comprises, after the first contacting step but before the lithium ion scavenging step, removing the first glass-ceramic article from the molten salt bath.

13. The method of claim 1, wherein the second glass-ceramic article is not subjected to a mechanical polishing step to mechanically abrade at least a portion of a surface thereof sufficient to remove at least a portion of a line defect and/or a low index layer, if present.

14. The method of claim 1, wherein the second glass-ceramic article:
is substantially free of line defects; and
is substantially free of a low index layer.

15. The method of claim 1, wherein the second glass-ceramic article has, when measured at a thickness of 0.55 mm, at least a portion comprising:
an opacity of 5 to 99%;
an Sq surface roughness of 0.0005-0.005 μm;
a haze of 10-60%;
a CT*TA of 3500-7000 MPa²*μm; or
any combination thereof.

16. The method of claim 1, wherein the second glass-ceramic article comprises:
a petalite crystalline phase; and
a lithium silicate crystalline phase.

17. The method of claim 16, wherein the second glass-ceramic article has a composition at its center comprising:
55-80 wt. % SiO₂;
2-20 wt. % Al₂O₃;
5-20 wt. % Li₂O;
0-5 wt. % Na₂O;
0-5 wt. % K₂O;
>0-5 wt. % CaO;
>0-6 wt. % P₂O₅; and
0.2-15 wt. % ZrO₂;
wherein ZrO₂ wt. %+P₂O₅ wt. %>1 wt. %.

18. The method of claim 17, comprising at least one of:
2-10 wt. % Al₂O₃;
10-20 wt. % LizO;
>0-3 wt. % Na₂O;
>0-3 wt. % K₂O;
>0-3 wt. % CaO;
>0-4 wt. % P₂O₅;
3-15 wt. % ZrO₂; and
ZrO₂ wt. %+P₂O₅ wt. %>3 wt. %.

19. A method for ion-exchanging glass-ceramic substrates, the method comprising:
a first contacting step comprising contacting a first glass-ceramic substrate with a molten salt bath comprising a lithium ion buffer and at least one of NaNO₃ and KNO₃, whereby (1) lithium ions diffuse from the first glass-ceramic substrate into the molten salt bath to provide a first dissolved lithium ion concentration, and (2) at least one of sodium and potassium ions diffuse from the molten salt bath into the first glass-ceramic substrate, thereby forming a first glass-ceramic article;
a pH adjusting step comprising adding a pH modifier to the molten salt bath that adjusts a pH of the molten salt bath;
a lithium ion scavenging step comprising contacting a lithium ion scavenger with the molten salt bath that, in conjunction with the lithium ion buffer, adjusts the first dissolved lithium ion concentration, wherein the lithium ion scavenger comprises a sodium-containing glass-based material having a different composition than the first glass-ceramic substrate;
wherein the pH adjusting and lithium ion scavenging steps (1) take place simultaneously or sequentially in any order, and (2) in combination provide a regenerated molten salt bath having a pH of 9-11 and a second dissolved lithium ion concentration of 115-250 ppm based on 100 wt. % of a sum total of NaNO₃ and KNO₃, if present; and
a second contacting step comprising contacting a second glass-ceramic substrate with the regenerated molten salt bath, whereby (1) lithium ions diffuse from the second glass-ceramic substrate into the regenerated molten salt bath, and (2) at least one of sodium and potassium ions diffuse from the regenerated molten salt bath into the second glass-ceramic substrate, thereby forming a second glass-ceramic article.

20. A glass-ceramic article, comprising:
first and second primary surfaces, the first primary surface comprising a textured region, a void having an edge, or both the textured region and the void having the edge;
a first compressive stress layer extending from the first primary surface to a first depth of compression (DOC1) and a second compressive stress layer extending from the second primary surface to a second depth of compression (DOC2);
a central tension region extending from DOC1 to DOC2; and
at least one region that satisfies Equation 1:
$$\vert \frac{( {Ca}_{n} - {Ca}_{n \pm 1} )}{{Ca}_{n}} \vert \times 100 > 15 \% ; \qquad ( Equation 1 )$$
wherein Caₙ is an average normalized intensity of calcium in a first 50 nm region, Ca_{n±1} is an average normalized intensity of calcium in a second 50 nm region immediately adjacent to the first 50 nm region, both the first and second 50 nm regions are within a depth of 25 nm to 5000 nm from the first primary surface, and both Caₙ and Ca_{n±1} are measured by SIMS analysis;
wherein at least one of the textured region and the edge, if present, is substantially free of line defects; and
wherein at least one of the textured region and the edge, if present, is substantially free of a low index layer.
